(19) United States
(12) Patent Application Publication
(10) Pub. No.: US 2015/0120337 A1
(43) Pub. Date: Apr. 30, 2015

(54) COMPUTER SYSTEM FOR FINANCE INVESTMENT MANAGEMENT

(71) Applicant: The QLS Program LLC, Sausalito, CA (US)

(72) Inventor: Philip F. Spalding, Novato, CA (US)

(21) Appl. No.: 14/524,958

(22) Filed: Oct. 27, 2014

Related U.S. Application Data
(60) Provisional application No. 61/895,907, filed on Oct. 25, 2013.

(51) Int. Cl. G06Q 40/06

(52) U.S. Cl. CPC G06Q 40/06; G06Q 40/08
USPC 705/4

(57) ABSTRACT

According to a profit sharing plan, the plan may sell stocks, bonds, etc. to purchase a life insurance policy. The life insurance policy may then be sold to the plan owner or a Grantor Trust for the fair market value of the life insurance plan. The plan owner or Grantor Trust will then owe the qualified plan the fair market value for the purchased life insurance policy. In some examples, traditional investments may be used to fulfill the Bill of Sale. Next, the qualified plan may be re-characterized into an IRA, which is subsequently converted to a Roth IRA. Upon conversion to a Roth IRA, the owner will owe income tax on the plan. The income tax may be paid with a loan or other method that withdraws funds from the life insurance policy or encumbers the life insurance policy

### CROSS-REFERENCES TO PRIORITY AND RELATED APPLICATIONS

This application claims priority from and is a non-provisional of U.S. Provisional Patent Application No. 61/895,907, filed Oct. 25, 2013 entitled “Computer System for Financial Investment Management.” The entire disclosure of application recited above is hereby incorporated by reference, as if set forth in full in this document, for all purposes.

### BACKGROUND

A typical person or family will set aside assets during their working years (accumulation phase) to draw on them later during retirement (spending phase). They will often seek advice from financial professionals to develop a retirement plan because the tax treatment and investment options with different assets and planning approaches are so numerous. Even without changing the tax structure imposed on investments and assets, individuals will want to do financial planning in order to maximize the assets that are working for them during the accumulation phase.

One such decision is whether to use a qualified tax retirement planning asset, and another decision is what type of asset to use. These decisions might be part be driven by what the investor qualifies for. Examples include traditional qualified plan assets, such as individual retirement accounts (“IRAs”), 401(k) accounts, Keogh accounts, Profit Sharing Plan accounts, etc., wherein post-tax or pre-tax funds are placed in the accounts during the accumulation phase, and taxes are paid on withdrawn amounts during the spending phase. Another example is a “Roth IRA” in which an individual retirement account is converted into a Roth IRA or post tax funds are placed in a Roth IRA and may be withdrawn tax-free. Yet another example are general investment accounts that hold assets bought with post-tax dollars with taxes paid on gains as determined by various tax laws, at the time of realizing a gain.

One approach to retirement investing is to have a permanent life insurance policy (e.g., whole life or universal life), in which cash values can be withdrawn or borrowed upon and provides a tax-free death benefit.

Historically, one of the most efficient ways to build retirement assets is to take advantage of making pre-tax contributions to a qualified plan. The contributions to a qualified plan are “deferred” from an income tax perspective and are allowed to grow free of capital gains tax. For U.S. federal tax purposes, the U.S. Department of Labor (“DOL”) and the U.S. Treasury's Internal Revenue Service (“IRS”) have strict rules on the amount a taxpayer can contribute to a qualified plan annually and equally strict rules on the amount and timing of the plans taxable distributions. Contributions are subject to dollar amount limitations depending on the plan type. Distributions rules are similar among qualified plan types. Generally, taxable distributions start at age 70.5 based on IRS Required Minimum Distribution tables and are designed to empty the plan balance by age 100. In general, early distributions (those prior to age 59.5) are allowed but subject to a 10% income tax penalty.

An alternative to the traditional qualified plan approach described above is the Roth IRA. In a Roth IRA, the taxpayer chooses to pay the income tax up front on plan assets and/or contributions now in exchange for tax-free growth long term. With a Roth IRA, there are no required minimum distributions (“RMDS”) during the taxpayer's lifetime. This, however, can change for the ultimate beneficiaries of a Roth IRA, where minimum distribution tables can come into play based on the life expectancy of the beneficiary. One downside to the Roth IRA approach is the requirement to pay the income tax on plan assets upfront. The economics (and effectiveness) of taking the Roth IRA approach depend on (1) the current and estimated future income tax bracket of the plan participant, (2) the growth rate of the funds in the Roth IRA, and (3) the length time the account can grow and compound before the funds are withdrawn. In general, most advisors agree that Roth IRAs work best for those at younger ages because the funds in the account need time to compound to make up for the initial tax loss.

A traditional general investment account is the least tax efficient but the most flexible. The account is generally funded with after tax dollars. The growth is typically subject to capital gains tax (on realized gains) and can be partially subject to income taxes if dividends are paid. There are no restrictions on contributions to an investment account and there are no restrictions on distributions as well. If held as an asset of the estate, the full value of unused assets at death can be subject to estate tax depending on the decedent's net worth and the plan of estate disposition.

Permanent life insurance can come in the form of universal life or whole life. There are many different variations of these products in terms of their cost, design, and investment components. In general, they are typically designed to provide life insurance on a long-range basis as well as offer a tax-favored investment account. The funding of a life insurance contract is done most typically with after tax dollars. However, in certain circumstances, some qualified plans allow for the funding of life insurance premiums with pre-tax dollars.

### SUMMARY

A method and apparatus, using computer hardware and/or computer software that can be processed by a processor and memory storage, for managing data related to a multi-part retirement investment strategy. The parts include the investor qualifying (or having been qualified) for a qualified plan that allows for the purchase of a life insurance policy as a plan asset. Such life insurance policy would be insurance on the life of the plan owner and/or their spouse (as allowed in the Department of Labor (“DOL”) Prohibited Transaction Class Exemption Expansion 92-6). Another part would be the sale of the life insurance policy, after at least some time period, to the investor/plan owner outside of the qualified plan, such as directly or via a grantor trust where the plan investor is the sole grantor of that trust. The life insurance policy must be sold out of the qualified plan for its fair market value (“FMV”). The United States Department of Treasure issued “safe-harbor” valuation rulings and guidance on the FMV of a life insurance contract that is either distributed or sold out of a qualified plan in Rev. Proc. 2005-25. The investor pays for the life insurance policy using non-qualified traditional assets to buy the policy from the qualified plan for its fair market value. Following the buy-out of the policy from the qualified plan, the plan participant goes through the common steps to eventually convert the new qualified plan balance to a Roth IRA. This typically involves first re-characterizing the qualified plan to an IRA and then converting the IRA to a Roth IRA. The tax due on the Roth IRA conversion is paid with funds borrowed from the previously acquired life insurance policy or borrowed using the previously acquired life insurance policy as collateral for a third party loan to pay the tax due on the Roth IRA conversion. As the life insurance policy builds value, it can be designed to eventually repay the principal on the Roth IRA tax loan from either cash values or death benefits. As described below, the steps and structure of this strategy can be applied to one or a combination of three common planning objectives: Enhancement of retirement income, wealth transfer or estate planning and charitable planning. The ultimate ownership and/or beneficiary of the assets involved in the transaction determine the planning approach taken.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is an example embodiment of an environment for implementing aspects in accordance with various embodiments;

FIG. 2A is an illustrative example of a block diagram of a profit sharing plan use to purchase a life insurance policy according to example embodiments of the present disclosure;

FIG. 2B is an illustrative example of a block diagram of a life insurance policy as sold to a qualified plan owner or grantor trust according to example embodiments;

FIG. 3 is an illustrative example of a block diagram of a plan owner paying the fair mark value to the qualified plan according to embodiments presented herein;

FIG. 4 is an illustrative example of a block diagram that provides a view of the process sharing plan, individual retirement arrangements, and the Roth IRA according to an embodiment of the present disclosure;

FIG. 5 is an illustrative example of a block diagram for using the life insurance policy to pay income tax according to an embodiment of the present disclosure;

FIG. 6 is an illustrative example of a block diagram according to example embodiments of the present disclosure;

FIG. 7 is an illustrative example of a block diagram according to example embodiments of the present disclosure;

FIG. 8 is an illustrative example of a block diagram according to example embodiments of the present disclosure;

FIG. 9A shows an illustrated example of a portion of a program for using the system according to embodiments presented herein;

FIG. 9B shows an illustrated example of a portion of a program for using the system according to embodiments presented herein;

FIG. 9C shows an illustrated example of a portion of a program for using the system according to embodiments presented herein;

FIG. 9B shows an illustrated example of a portion of a graphical user interface in which various embodiments of the present disclosure may be practiced;

FIG. 9C shows an illustrated example of a portion of a graphical user interface in which various embodiments of the present disclosure may be practiced;

FIG. 10A shows an illustrated example of user interface in which various embodiments of the present disclosure may be practiced;

FIG. 10B shows an illustrated example of a portion of a user interface in which various embodiments of the present disclosure may be practiced;

FIG. 10C shows an illustrated example of a portion of a user interface in which various embodiments of the present disclosure may be practiced;

FIG. 11 shows an illustrated example of a dashboard in which various embodiments of the present disclosure may be practiced;

FIG. 12 shows an illustrated example of a dashboard in which various embodiments of the present disclosure may be practiced;

FIG. 13 shows a swim diagram in which various embodiments of the present disclosure may be practiced;

FIG. 14 shows a swim diagram in which various embodiments of the present disclosure may be practiced; and

FIG. 15 illustrates aspects of an example environment for implementing aspects in accordance with various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described and suggested herein include methods and computer-readable storage mechanisms configured for repositioning both pre-tax dollars and after-tax dollars into more tax efficient structures. Repositioning of assets include trading pre-tax qualified plan assets for a tax-free life insurance policy and trading traditional after-tax investments assets for a tax-free Roth IRA and a loan.

For example, according to a profit sharing plan, the plan may sell stocks, bonds, etc. to purchase a life insurance policy. Currently, after at least two years, the life insurance policy may then be sold to the plan owner or a Grantor Trust for the fair market value of the life insurance policy. In other words, qualified plan assets are traded for a tax-free life insurance policy. The plan owner or Grantor Trust will then owe the qualified plan the fair market value for the purchased life insurance policy. In the case where the Grantor Trust is the purchaser, subsequent gifts or loans can be made to said trust so it has capital to purchase the policy from the qualified plan. For example, the qualified plan owner may gift or loan monies to the Grantor Trust. In some examples, traditional investments may be used to fulfill the Bill of Sale. Next, the qualified plan may be re-characterized into an IRA, which is subsequently converted to a Roth IRA.

In some example embodiments, a policy owner may re-characterize their profit sharing plan into an IRA, and then convert the IRA into a Roth IRA. In alternative example embodiments, a qualified plan may contain a Roth provision, such that the policy owner does not have to re-characterize the plan into an IRA, but may simply convert the profit sharing plan into a Roth IRA when the plan has such a Roth provision.

Upon conversion to a Roth IRA, the owner will owe income tax on the plan. The income tax may be paid with a loan or other method that withdraws funds from the life insurance policy or encumbers the life insurance policy. For example, funds may be borrowed or lent from the life insurance policy directly, or the life insurance policy may be used as collateral for a loan, such as a bank loan. As a tax loan will accrue interest costs, the interest costs for the tax loan may be paid for (up to) the life of the insured. Some life insurance contracts allow for wash loans, participating loans, or the like, whereas the dollars borrowed also earn interest thus enhancing the leverage on borrowed funds. The principal costs for the tax loan may be paid with cash withdrawals, cash loans, or the death benefits of the life insurance policy, for example. In other words, traditional investments may be traded for a Roth IRA and a loan.

Example embodiments include a computer system configured to provide accounting support for a method of financial planning. This can improve an investor's retirement income, decrease his or her estate tax liability and/or increase the amount that, or change the timing of what, is donated to charity by reallocating a specific set of assets. These techniques address constraints on limitations on the amount of assets that become relevant or applicable, the type of asset classes used and the order in which the assets are reallocated. A web-based computer planning software system can be used to effect and/or demonstrate such an operation. In alternative example embodiments, the computer planning software system may be locally installed on a customer's enterprise network, such as behind a customer's firewall or other network security.

Although the system may create efficiency for a taxpayer, this method and process does not reduce, discount, or avoid the taxpayer's liability to taxing authorities, except as might incidentally occur.

An example embodiment of the web-based computer planning software system can demonstrate the method using assets such as (1) Traditional Qualified Plan assets (IRA, 401(k), Keogh, Profit Sharing Plan), (2) Roth IRA, (3) General Investment Account (Stocks and bonds), (4) Permanent Life Insurance Policy (Whole Life or Universal Life), and/or (5) A loan to pay the tax on the Roth IRA conversion.

A Roth IRA is a certain type of retirement plan that is generally not taxed, and the tax break is granted on the money withdrawn from the plan during retirement. In contrast, a traditional IRA, while contributions are often tax-deductible, all transactions and earnings within the IRA have no tax impact, and withdrawals at retirement are taxed as income, generally.

From a tax perspective, life insurance enjoys some unique benefits in the tax code. For example, the death benefit of a properly owned and structured traditional permanent life insurance contract is tax-free. Many permanent life insurance contracts are also designed to build cash values that also grow tax-free. If properly designed, access to the cash values in a life insurance contract can also be taken on a tax-free basis in the form of policy withdrawals and loans.

As shown in the software system and/or web-based software system and processes, the tax efficiency for a specific set of assets that are typical for U.S. taxpayers can be improved. Further illumination of the process can be explained using examples below.

The example below describes a process using a traditional IRA with a traditional investment account (also referred to as a conventional approach).

Bob is a successful doctor. At the age of 45, he has accumulated $822,250 in a Profit Sharing Plan and an additional $716,328 in a brokerage account. Bob will make additional (after tax) deposits into his brokerage account of $20,000/year from ages 50 to 64. While it would be more tax efficient for Bob to make deposits into his pre-tax qualified plan account, additional contributions to a qualified plan can be done with or without the described methods with equal effect, so they are not part of the comparison presented here. At age 65, Bob will retire and draw income for his retirement from both accounts.

The additional assumptions are as follows: All assets are assumed to grow at 6.90% (pre-tax) per annum, a 40% tax bracket on all growth and income of the assets, an asset management fee of 1% will be charged every year on all assets, and income will be taken in level amounts from both assets from age 65 to 85 (20 years). For the purpose of simplicity, income will be withdrawn from both assets at level amounts. In alternative examples, withdrawing only RMDs may be more efficient, but is outside the scope of the instant example.

Based on this traditional/convention approach, the tax treatment of these assets in their funding, growth and distribution can be described as follows:

Traditional Qualified Plan and Asset Account

| | Funding | | Growth | | Distribution | | | |
|---|---|---|---|---|---|---|---|---|
| Asset Type | Pre-tax | After-tax | Tax-free | Taxable | Tax-free | Taxable | Income 20/yrs | Bal age 86 |
| QP | $822,250 | | x | | | x | 131,787 | 0 |
| Trad. Asset | | $716,328 | | x | x | x | 157,343 | 0 |

| | | | |
|---|---|---|---|
| additional deposit of 20k/yr ages 50 to 64 | Totals | $289,130 | 0 |

In a second example, a Roth IRA with a traditional investment account is described. In this approach, all of the tax and growth assumptions are the same as shown in the convention approach above. At the age of 45, Bob has $716,328 in a brokerage account. As before, he has $822,250 in his traditional qualified plan (IRA) but he opts to convert the asset from an IRA to a Roth IRA. This leaves him $493,350 (after tax) to invest and grow tax-free. Assuming Bob takes the same maximum level withdrawals as described above, here are the results.

Roth IRA and Asset Account

| | Funding | | Growth | | Distribution | | Results age 65-86 | | |
|---|---|---|---|---|---|---|---|---|---|
| Asset Type | Pre-tax | After-tax | Tax-free | Taxable | Tax-free | Taxable | | Income 20/yrs | Bal age 86 |
| Roth IRA | $822,250 | $493,350 | x | | x | | | 131,786 | 0 |
| Trad. Asset | | $716,328 | | x | x | x | | 157,343 | 0 |

| | | | |
|---|---|---|---|
| additional deposit of 20k/yr ages 50 to 64 | Totals | $289,129 | 0 |

Based on the above two results, it seems as if both approaches yield the same so there is no clear winner. It is true that paying the tax now versus later yields the same results, however, there is a distinct difference: the Roth IRA offers flexibility in future distributions. The example does not take into account that a regular IRA will require minimum distributions starting at age 70.5 and, therefore, force taxation. Flexibility may make the Roth IRA preferred because the account can continue to grow tax-free. In addition, the Roth IRA can be passed down to the next or future generations and provide additional tax leverage/advantage as an inherited Roth IRA. With an inherited Roth IRA, the balance is subject to estate tax at the time of transfer, but a large balance of the account can grow income tax free. Required minimum distributions become relevant with an inherited Roth IRA; however, the require minimum distributes are tied to the inheritor's age.

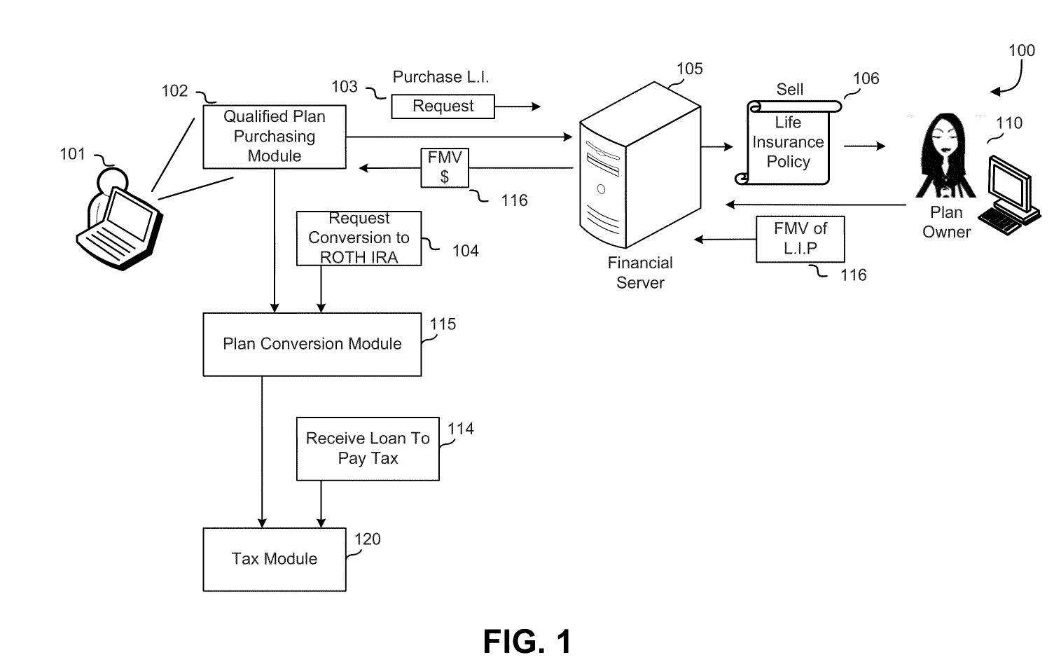

FIG. 1 is an example embodiment of an environment 100 for implementing aspects in accordance with various embodiments. As will be appreciated different network environments, such as nodes and servers in a computer network operably interconnected via an Internet, may be used, as appropriate, to implement various embodiments.

Example embodiments of the present disclosure include methods and computer-readable storage mechanisms configured for repositioning both pre-tax dollars and after-tax dollars into more tax efficient structures. A customer 101 via a user device may send a request to a qualified plan purchasing module 102 for repositioning of the customer's assets including trading pre-tax qualified plan assets for a tax-free life insurance policy and trading traditional after-tax investments assets for a tax-free Roth IRA and loan.

For example, according to qualified plan module (also referred to as a profit sharing plan), the plan purchasing module may be configured to request to purchase a life insurance policy 103 to a financial server 105, using, for example, stocks, bonds, etc. for the purchase. Example embodiments of a financial server 105 may include investment companies, life insurance companies and other insurance companies' computer systems, networks, or enterprise networks. The life insurance policy may then be sold 106 to the plan owner 110 or a Grantor Trust for the fair market value of the life insurance plan. In other words, qualified plan assets are traded for a tax-free life insurance policy. The plan owner or Grantor Trust will then owe the qualified plan the fair market value 116 for the purchased life insurance policy; this may be transferred to the plan via the financial server 105, or directly to the qualified plan-purchasing module. In some examples, traditional investments may be used to fulfill the Bill of Sale. Next, the qualified plan may be re-characterized into an IRA according to a request 104 transmitted to a plan conversion module 115, which is subsequently converted to a Roth IRA.

Upon conversion to a Roth IRA, the owner will owe income tax on the plan. The income tax 114 may be paid to a tax module 120 (which could be a financial institution or the government) with a loan or other method that encumbers the life insurance policy. For example, funds may be borrowed or lent from the life insurance policy directly, or the life insurance policy may be used as collateral for a loan, such as a bank loan. As a tax loan will accrue interest costs, the interest costs for the tax loan may be paid for (up to) the life of the insured. The principal costs for the tax loan may be paid with cash or the death benefits of the life insurance policy, for example. In other words, traditional investments may be traded for a Roth IRA and a loan.

In an example embodiment of the present disclosure where there is a loan to pay the tax on the Roth IRA, when structured properly, the life insurance policy can build value and eventually pays back all or part of the principal on the Roth IRA tax loan from either cash values or death benefits.

As shown in the economic explanation below, the total funds used for this transaction are generally identical to the other two approaches. Assets may be reallocated by making the two following trades:

Trade 1: Assets are taken that were growing tax deferred inside a qualified plan and moved out of the qualified plan (when properly structured) to grow tax-free inside a life insurance policy and/or deliver a tax free death benefit.

Qualified plan assets are at first tax deferred, but eventually subject to a 40% income tax hit when the qualified plan assets are distributed. In addition, wealthy taxpayers could face an additional 40% loss due to estate taxes on plan assets that remain in the estate.

In some example embodiments, the qualified plan may be traded for a life insurance policy that, when properly structured, allows for tax-free growth and has cash values that can be accessed tax-free. Structured properly, the death benefits can also be free of estate tax.

According to example embodiments of the charitable planning approach disclosed herein, taxpayers that planned to give the balance of their qualified plan to charity at their death, can give up to the full value of their qualified plan to a charity during their lifetime.

The long-term acquisition cost of a life insurance policy varies over time and is different for every client (based on age, product, and health rating).

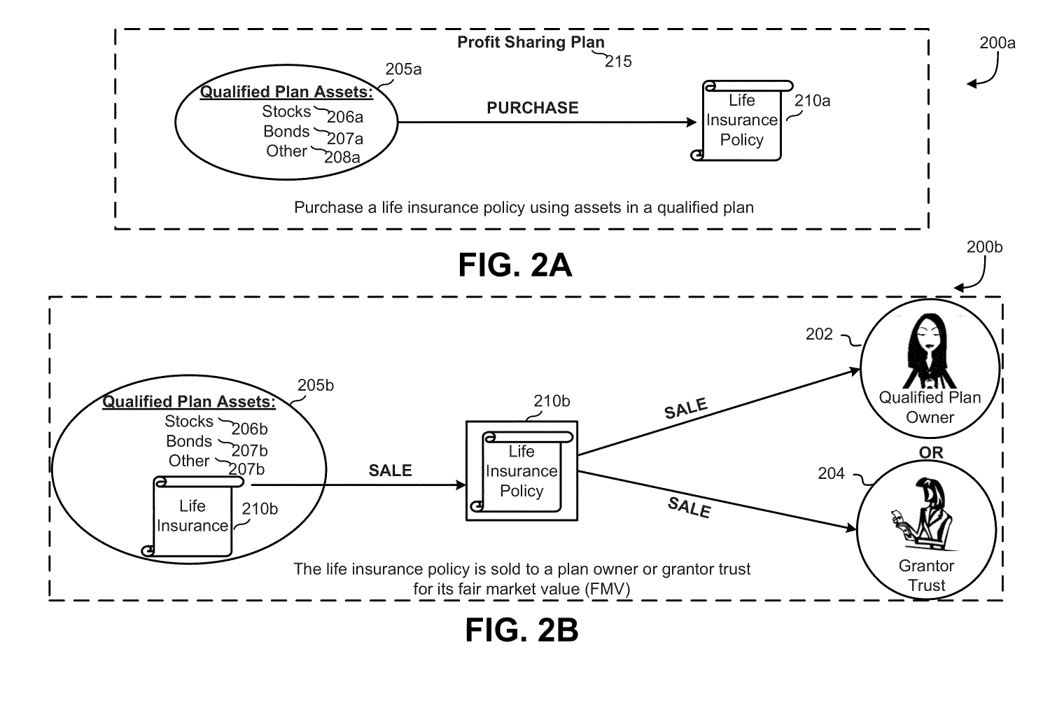

FIG. 2A is an illustrative example of a block diagram 200a of a profit sharing plan use to purchase a life insurance policy according to example embodiments of the present disclosure. The profit sharing plan purchase may be performed, for example, by various components of the qualified plan purchasing module 102 as described and depicted in connection with FIG. 1. For example, according to qualified plan module (also referred to as a profit sharing plan), the plan purchasing module may be configured to request to purchase a life insurance policy 210a using profit sharing plan assets, such as stocks, bonds, etc. for the purchase.

FIG. 2B is an illustrative example of a block diagram 200b of a life insurance policy as sold to a qualified plan owner or grantor trust according to example embodiments. The life insurance sale may be performed, for example, by various components of the financial server 105 as described and depicted in connection with FIG. 1.

The life insurance policy 210b may then be sold to the plan owner 202 or a Grantor Trust 204 for the fair market value of the life insurance plan. In other words, qualified plan assets are traded for a tax-free life insurance policy. The sale may include the qualified plan assets 205b, such as stocks 206b, bonds 207b, and other assets 208b in the plan.

In the case where a life insurance policy is an asset of a qualified plan, the death benefit and cash values can be taxable as long as the policy remains as a plan asset. While the policy is a plan asset, the “economic benefit” of the policy can be realized as income to the plan owner thereby making the death benefit tax-free until it is sold out of the qualified plan. According to example embodiments of the present disclosure, the funding of the policy will be on a pre-tax basis; however, as the policy will be sold out of the qualified plan, the cash value and death benefits can be structured to be tax-free (as described and illustrated below).

An example of tax treatment of the previously mentioned asset classes based on their funding, growth and distribution is provided below.

| | Funding | | Growth | | Distribution | |
|---|---|---|---|---|---|---|
| | Pre- | After- | Tax- | | Tax- | |
| Asset Type | tax | tax | free | Taxable | free | Taxable |
| Qualified Plan | x | | x | | | x |
| Roth IRA | | x | x | | x | |
| Traditional Asset | | x | | x | x | x |
| Life Insurance | x | | x | | x | |

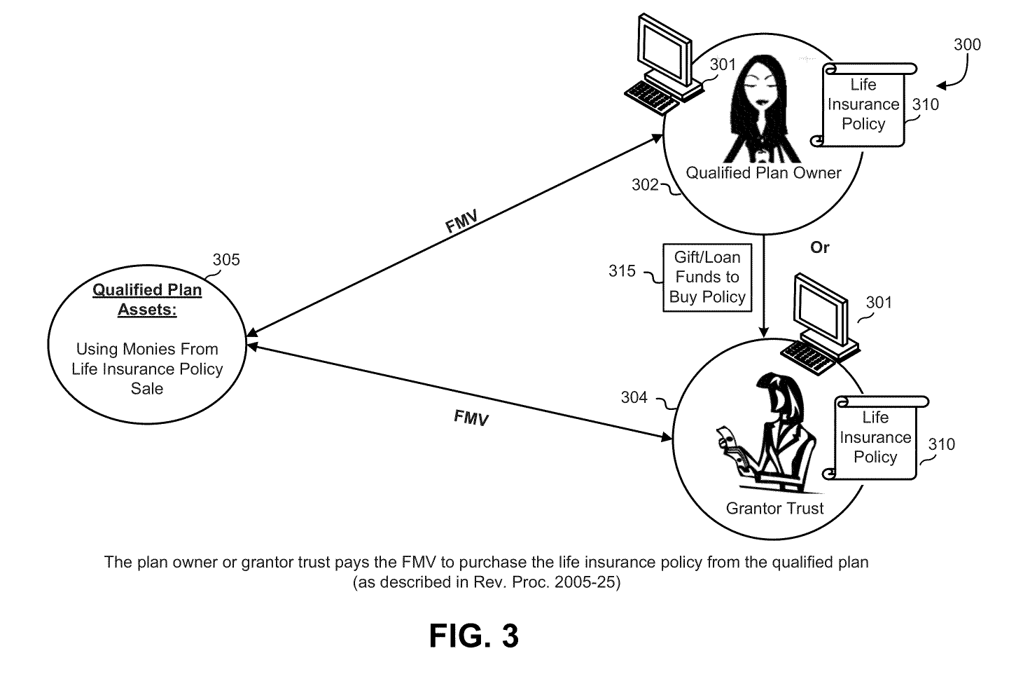

FIG. 3 is an illustrative example of a block diagram 300 of a plan owner paying the fair mark value to the qualified plan according to embodiments presented herein. The plan owner 302 or Grantor Trust 304 will then owe the qualified plan 305 the fair market value for the purchased life insurance policy 310; this may be transferred to the plan via the financial server, or directly to the qualified plan-purchasing module. In the embodiment of the Grantor Trust 304 paying the qualified plan for the FMV, the plan owner 302 would first gift or loan funds 315 to the Grantor Trust in order for the Grantor Trust to pay the FMV. Generally, the FMV provided under the Rev. Proc. 2005-25 related to the safe harbor valuations of the qualified plan is used for exemplary purposes within, it should be known by a person of ordinary skill in the art may use FMV based on other provisions or assumptions.

According to some example embodiments of the instant disclosure, some basic qualifications for an investor to implement this approach may include, first, that the investor should have (or qualify) for a qualified plan that has language that complies with the DOL rules allowing the plan to purchase life insurance and identify what plan assets can be used. For example, the qualified plan is preferably not a traditional IRA wherein life insurance is not allowed as an asset class and, second, the plan participant (and/or their spouse) preferably qualifies for a quality life insurance policy both medically and financially. Additionally, in most cases, only seasoned money (e.g., plan assets over two years' old) may be used to pay life insurance premiums.

Assuming the participant qualifies, the following basic steps might be taken. As described in the planning examples below, nuances to these steps regarding the ultimate ownership of the assets can be modified depending on whether the overall planning objective is to increase retirement income, transfer wealth, and/or make a charitable bequest or donation.

For example, the participant purchases a life insurance policy as an asset of his or her qualified plan. In most cases, the majority of the premiums needed for the life of the policy are paid in large deposits within the first two to five years; however, alternative payment methods are used. Additional premiums can be paid later from non-qualified plan assets, for example, if the overall design and planning objectives call for it.

Generally, sometime after a minimum of two years, the policy is sold to the participant directly or to a grantor trust where the plan participant is the sole grantor of the trust (complying with the exception to the transfer for value rules that otherwise would treat insurance proceeds as taxable income). This is allowed for and described in the DOL Prohibited Transaction Class Exemption Expansion 92-6. The sale price of the policy follows the IRS safe harbor valuation rules of Rev. Proc. 2005-25.

In some example embodiments, the plan owner/participant uses non-qualified traditional assets to buy the policy from the plan for its fair market value (“FMV”). If the participant's goal is strictly retirement planning, the participant can buy the policy directly from the qualified plan. If the planning objective is also estate planning to reduce estate taxes, the participant can make a gift or loan to a grantor trust. The trust, in turn, purchases the policy from the qualified plan. If charitable planning is the objective, the policy is first sold directly to the plan owner/participant and then donated to a tax-exempt charitable organization, a charitable trust, such as a Charitable Lead Annuity Trust (“CLAT”), for the benefit of a tax-exempt charitable organization.

Following the sale of the policy from the qualified plan, and having reimbursed the qualified plan for the policies FMV with other assets, the plan participant converts the new qualified plan balance (after taking the necessary steps as described, unless, for example, the qualified plan has a Roth IRA provision) to a Roth IRA. Assets, now in the new Roth IRA, can grow tax-free, despite being originally funded with dollars from outside the plan (e.g., a traditional investment account). Instead of paying for the tax due on the Roth IRA conversion with personal funds, the plan participant may use the previously acquired life insurance policy as a leveraged asset to provide funds to pay the tax on the Roth IRA conversion. For example, this payment may be performed by borrowing money from the life insurance policy itself or by using the policy as collateral for a loan to pay the tax due on the Roth IRA conversion. In an example of the estate planning approach, the Roth IRA tax may be paid as described above if the purchaser (e.g., the life insurance trust) is structured in a manner where funds can be transferred or removed from the life insurance trust to the plan owner or the plan owner's spouse.

For example, funds may be transferred or removed from the life insurance trust when the trust was originally funded with loans using the applicable federal rates (“AFR”) or when the trust has provisions of spousal access (e.g., a spousal access trust). To enhance the wealth transfer leverage/advantage, the Roth IRA can be given the beneficiary designation transferring income tax-free growth for a portion of the account to the next generation(s).

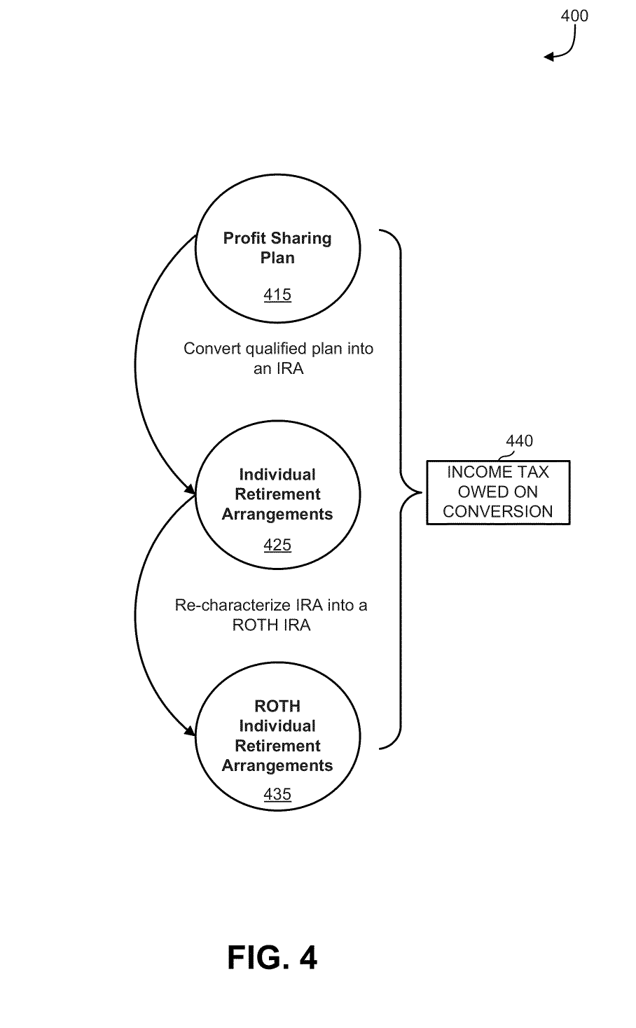

FIG. 4 is an illustrative example of a block diagram 400 that provides a view of the profit sharing plan, individual retirement arrangements, and the Roth IRA according to an embodiment of the present disclosure. The qualified plan may be re-characterized into an IRA according to a request to convert the qualified plan, which is subsequently converted to a Roth IRA.

In some example embodiments, a policy owner may re-characterize their profit sharing plan into an IRA, and then convert the IRA into a Roth IRA. In alternative example embodiments, a qualified plan may contain a Roth provision, such that the policy owner does not have to re-characterize the plan into an IRA, but may simply convert a percentage of the profit sharing plan into a Roth IRA when the plan has such a Roth provision.

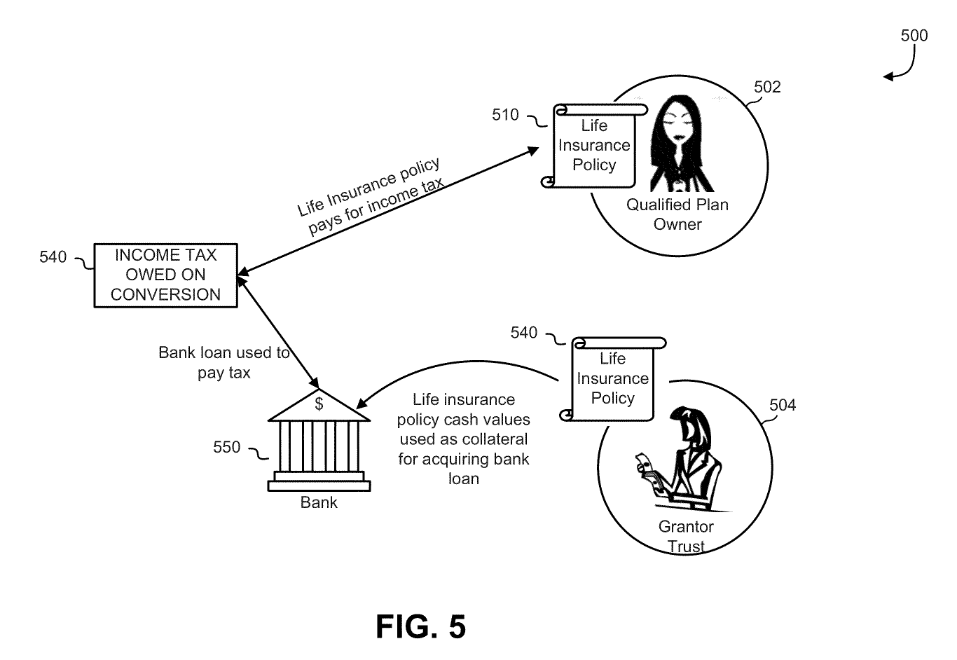

FIG. 5 is an illustrative example of a block diagram 500 for using the life insurance policy to pay income tax according to an embodiment of the present disclosure.

Upon conversion to a Roth IRA, the qualified plan owner 502 will owe income tax on the conversion. The income tax 540 may be paid to a tax module, such as the tax module described and depicted in connection with FIG. 1 (which could be a financial institution or the government) with a loan or other method that encumbers the life insurance policy. For example, funds may be borrowed or lent from the life insurance policy directly, or the life insurance policy may be used as collateral for a loan, such as a bank loan 550. As a tax loan will accrue interest costs, the interest costs for the tax loan may be paid for (up to) the life of the insured. The principal costs for the tax loan may be paid with cash or the death benefits of the life insurance policy, for example. In other words, traditional investments may be traded for a Roth IRA and a loan.

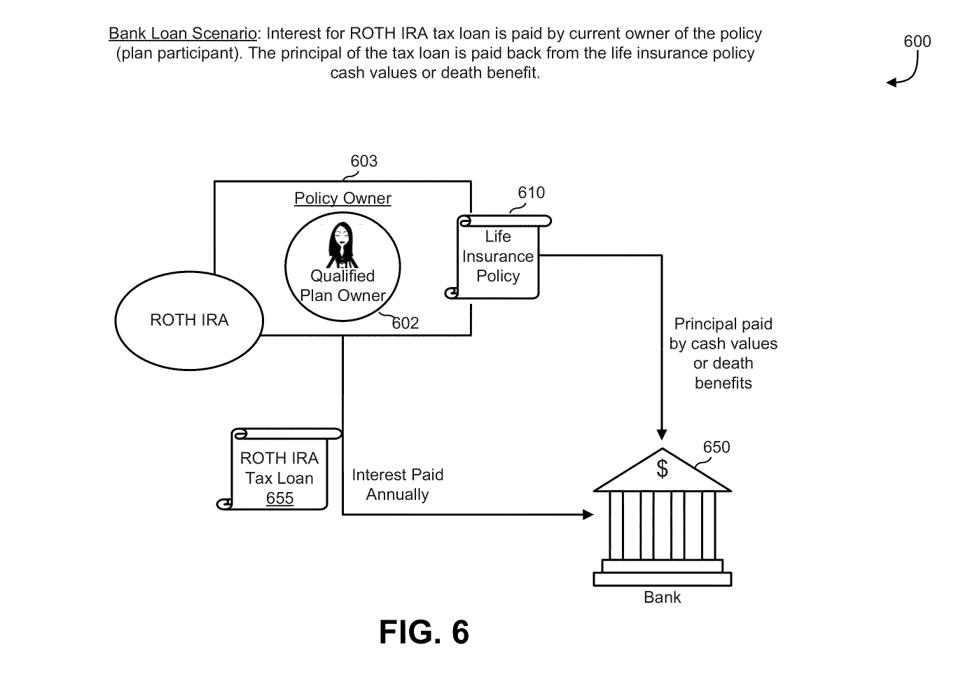

FIG. 6 is an illustrative example of a block diagram 600 depicting the use of a bank loan for paying the income tax as described and depicted in connection with FIG. 5. For example, interest for the Roth IRA tax loan 655 may be paid by current owner of the policy 603, which is the plan participant 602. The principal of the tax loan is paid back from the life insurance policy cash values or death benefit and the interest may be paid back annually to a bank 650. In alternative example embodiments, the interest for the Roth IRA tax loan may be paid by a grantor trust or other entity.

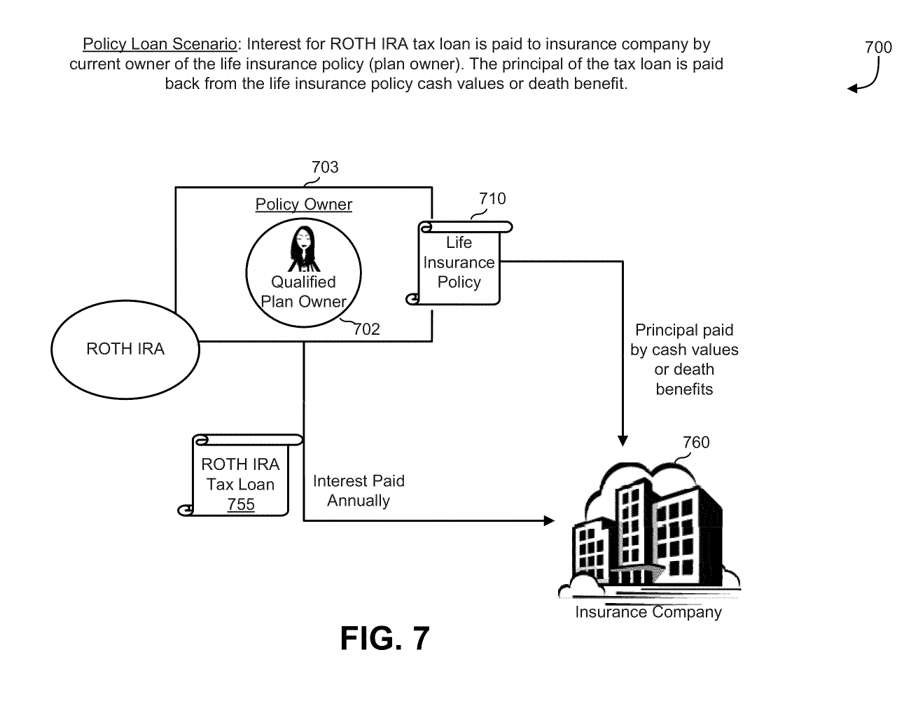

FIG. 7 is an illustrative example of a block diagram 700 depicting the use of an insurance company for paying the income tax as described and depicted in connection with FIG. 4. Interest for the Roth IRA tax loan 755 is paid by current owner of the policy 703 with the life insurance policy 710. The principal of the tax loan is paid back from the life insurance policy 710 cash values or death benefit using an insurance company 760. In alternative example embodiments, the interest for the Roth IRA tax loan may be paid by a grantor trust or other entity.

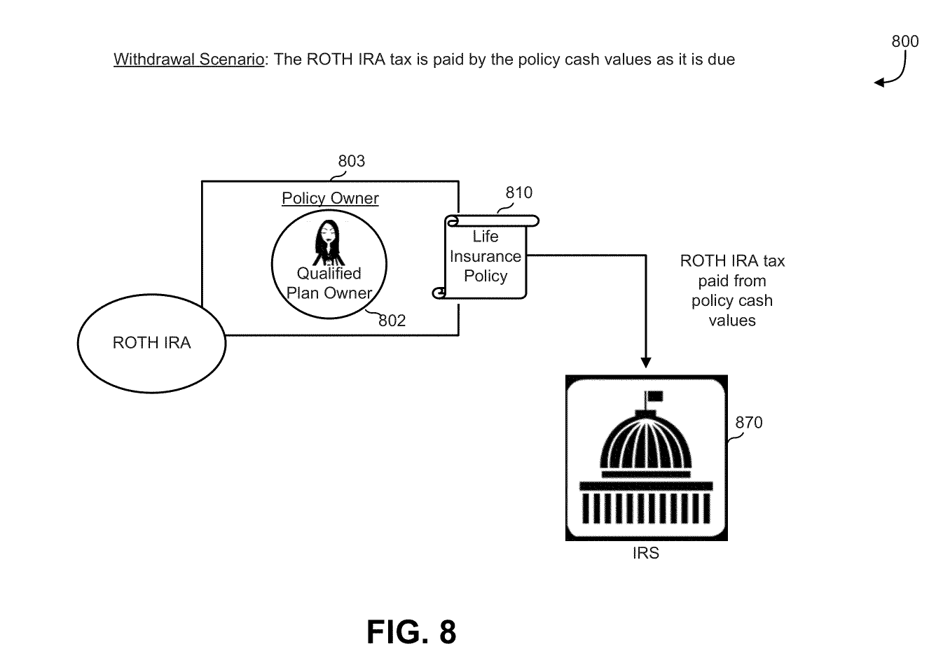

FIG. 8 shows an illustrated example of an environment 800 in which various embodiments of the present disclosure may be practiced. Specifically, the embodiment of FIG. 8 is similar to that of FIGS. 6 and 7; however, the Roth IRA tax is paid by the policy cash values, either policy loans or withdrawals from the life insurance policy 810, being held by the plan owner 803, which is either the qualified plan owner 802 or the grantor trust 804. The Roth IRA tax is paid to the IRS 870, as it is due.

In relation with FIGS. 6, 7, and 8, with all assumptions being equal, the following provides a summary of the sample case approach compared to the previous traditional plans described:

| Traditional IRA and Asset Account | | | Roth IRA and Asset Account | | | New Approach | | |
|---|---|---|---|---|---|---|---|---|
| | Results age 65-86 | | | Results age 65-86 | | Results age 65-86 | | |
| | Income | | | Income | | | Income | |
| | 20/yrs | Bal age 86 | | 20/yrs | Bal age 86 | | 20/yrs | Bal age 86 |
| Roth IRA | $131,786 | $0 | Roth IRA | $131,786 | $0 | Tax Loan | | |
| | | | | | | Roth IRA | $201,212 | $0 |
| Trad. Asset | $157,343 | $0 | Trad. Asset | $157,343 | $0 | Life Policy | $225,000 | $487,351 |
| Totals | $289,130 | $0 | Totals | $289,130 | $0 | Totals | $426,212 | $487,351 |

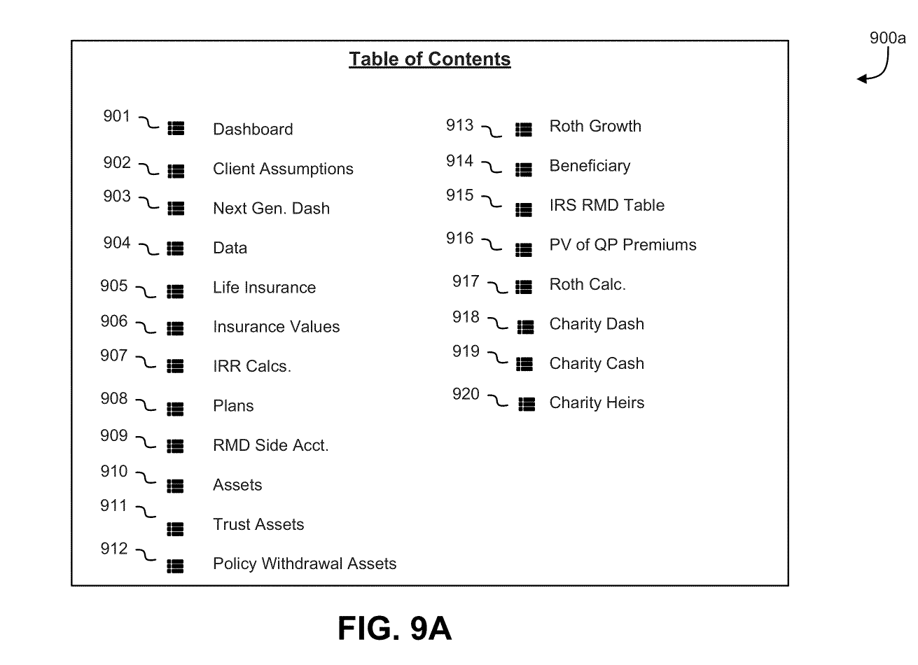

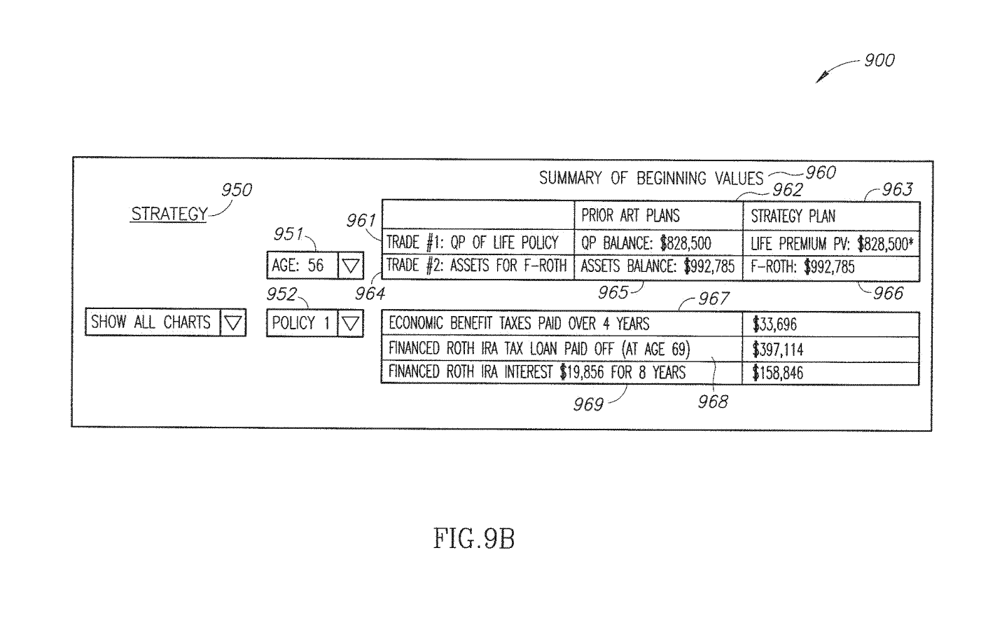

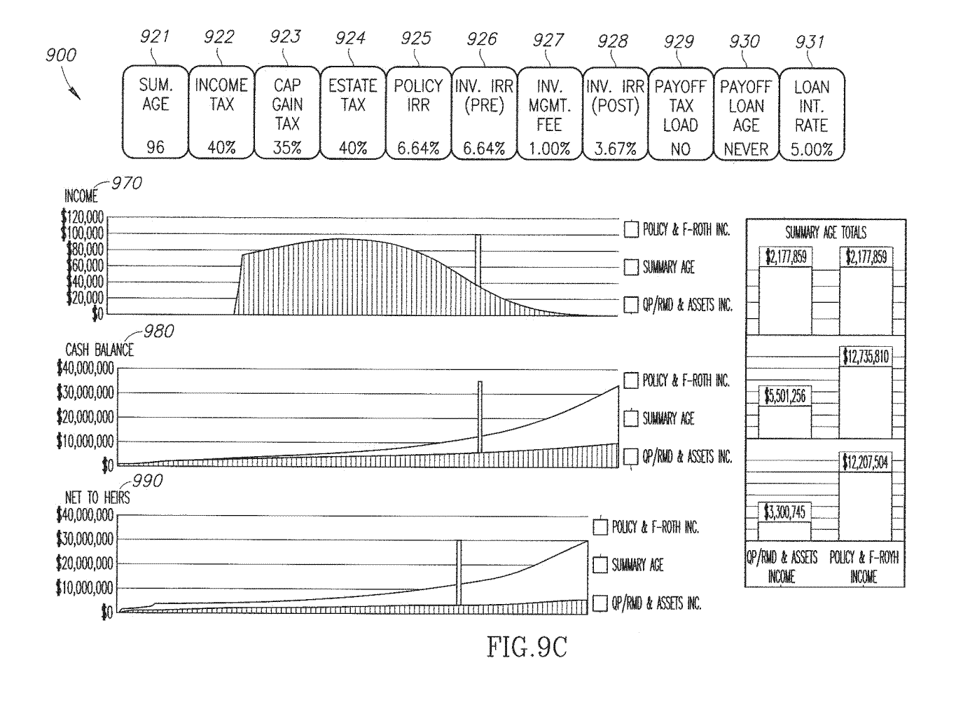

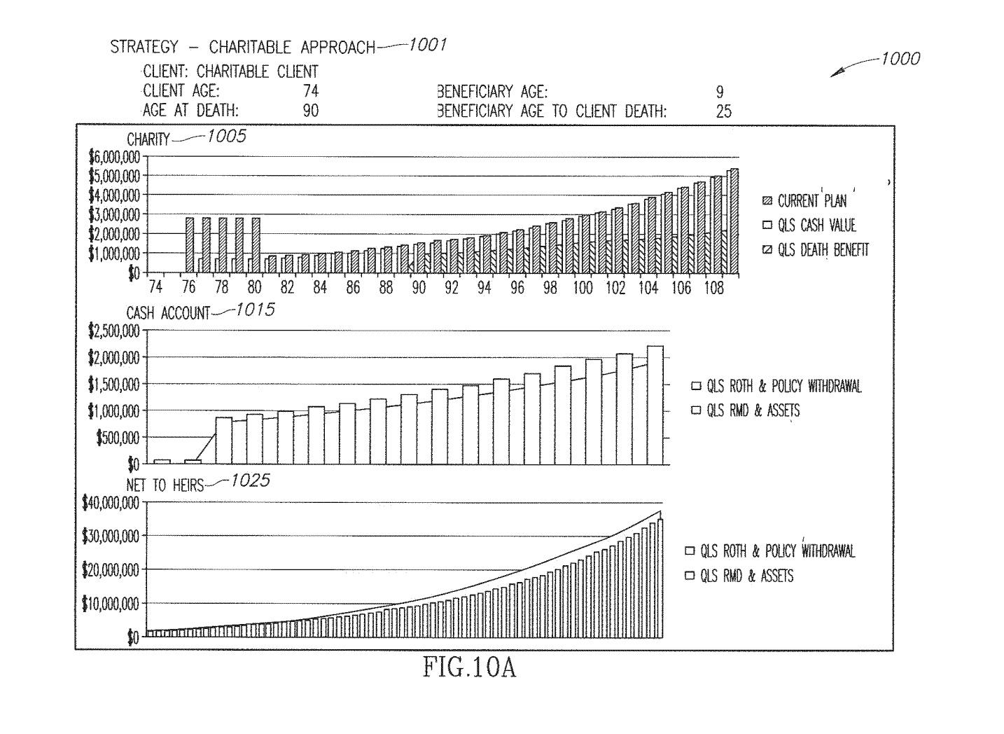

FIG. 9A shows an illustrated example of a portion of a program for using the system according to embodiments presented herein. The system and methods presented herein may include a web-based software instance running on a computer or a local software instance located on a user's network. The table of contents 999 enables a user to navigate among the portions of the system. The table of contents depicts a series of shortcut links to various tabs or pages of the software program presented in example embodiments throughout, including a Dashboard module 901, which provides the customer with access to most financial models, options, and entries related to the Trade 1 and Trade 2 processes.

Example embodiments of the client assumptions module 902 provide a summary of the data, such as tax rates, investment returns, life insurance policy information, loan interest, Roth IRA tax loan assumptions, etc. Next generation dashboard module 903 provides for the numerical comparison wealth transfer value, of strategies disclosed in example embodiments, to the next generation. Example embodiments of the data tab module 904, such as the example of Appendix A, includes universal inputs for different scenarios, life policy information, assets in qualified plans, assets in estate, Roth IRA conversion information, Roth IRA and loan information, beneficiary withdrawals, and level withdrawals, including all of the information and variables that may be used, in some or all example embodiments, according to the instant disclosure.

A life insurance module 905 provides for an extraction of the life insurance values from the insurance company software, such as an input from external software managed by the life insurance company. Life insurance values module 906 incorporates the numbers provided by the life insurance module into example embodiments of the software modules of the present disclosure. Example embodiments of the IRR calculations module 907 shows a comparative report of the rate of return achieved by implementing the strategy. The plans module 908 further provides for the overall tax effect of a qualified plan including Required Minimum Distributions (RMD), early withdrawal penalties, contributions and withdrawals beyond RMDs.

The table of contents further provides a link to the required minimum distributions (RMD) side account module 909 includes an account to show the required minimum distributions from the qualified plan shown as either income or a separate investment account.

Example embodiments of the assets module 910 are used to equalize the economics shown in the strategy. This includes, for example, providing for the opportunity cost of including the economic benefit, the growth of a side account to compare the results of Trade 2. For example, the ability to show interest deposits (for the Roth IRA tax loan in Trade 2), additional deposits and withdrawals to equalize additional insurance premiums and/or other designs inherent in the strategy. The trust assets module 911 includes information and data related to a separate account in order to provide a temporary placeholder or deal with any future life insurance premiums (treated in the trust as, for example, gifts or loans) after Trade 2 is completed. Policy withdrawal assets module 912 calculates the FMV when the life insurance policy is sold out of the qualified plan and subsequently gifted directly to a charity or a charitable trust and also includes a separate growth account for cash values withdrawn from the life insurance policy before it is gifted to the charity or charitable trust and the Roth Growth module 913 provides for the calculation of the Roth IRA in Trade 2 including additional deposits or withdrawals from the Roth IRA to, for example, provide income, pay insurance premiums or pay the interest or principal on the Roth IRA tax loan.

Beneficiary module 913 refers to the next generation dashboard module. The beneficiary module will display that the beneficiary will inherit a life insurance policy and a Roth IRA. The beneficiary module provides an extension of the Trade 1 and Trade 2 process and methods to a next generation in order to provide information and data on the inheritance, taxes, and similar financials as provided in the dashboard module.

The example embodiment of the table of contents further includes an IRS RMD table module 915 that provides for the applicable IRS tables associated with calculating Required Minimum Distributions on all applicable qualified plan assets in the model, a PV of the qualified plan premiums module 916 that provides for a calculation of the qualified plan balance present value as it relates to the insurance premiums needed in Trade 1, and a Roth IRA calculations module 917 that provides for additional models and calculations associated with the use of the Roth IRA in the transaction.

Charity dashboard module 918 provides for an example embodiment of the charitable approach disclosed herein, which provides the comparative values of a charity or charitable trust, comparing eventually inheriting a qualified plan versus providing example embodiments according to processes and methods according to example embodiments presented herein. Charity cash module 919 compares the lifetime cash position of the plan owner between implementing the strategies according to example embodiments of the present disclosure compared to a current plan of making a charity a qualified plan owner at death. The Charity Heirs module 920 provides information related to value to next generation comparing the current plan of leaving the qualified plan to charity, as opposed to implementing the strategy of example embodiments of the present disclosure.

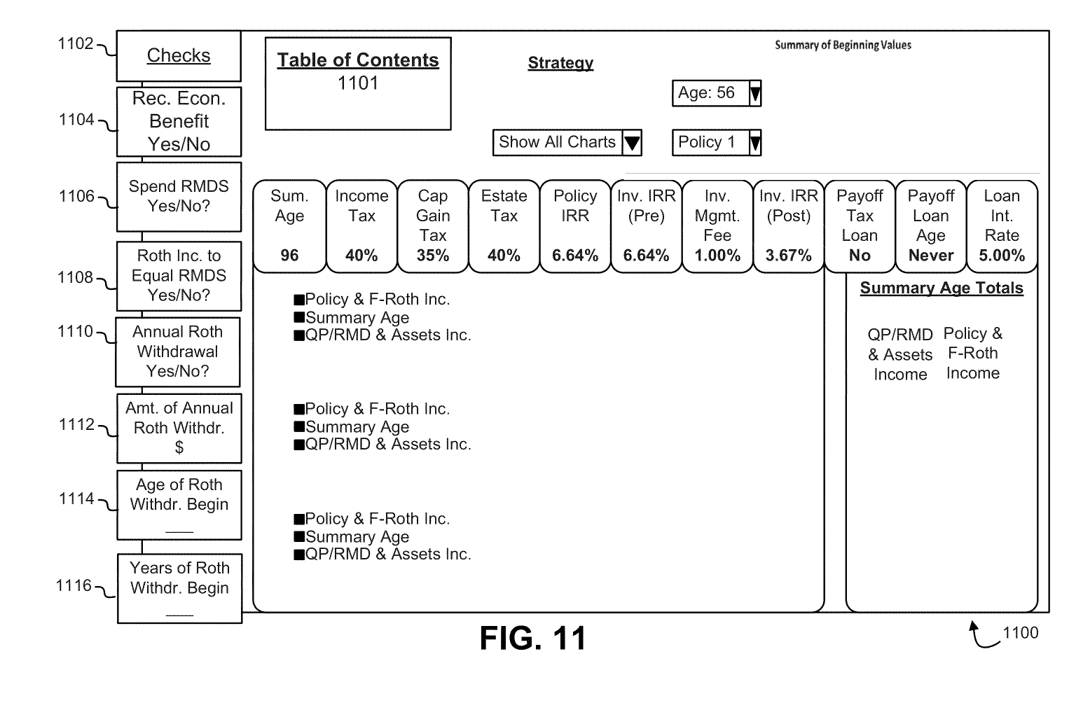

FIG. 9B shows an illustrated example of a portion of a graphical user interface 900b in which various embodiments of the present disclosure may be practiced. The system and methods presented herein may include a web-based software instance running on a computer or a local software instance located on a user's network. FIG. 9B depicts a portion of a user interface of the software instance providing a strategy 950, which includes a summary of beginning values 960 in order to provide and changeable view and numerical disclosure based on the interaction with the user interface. The user interface disclosed in FIG. 9B is a portion of a dashboard depicted in FIG. 11.

FIG. 9C shows an illustrated example of a portion of a graphical user interface 900c in which various embodiments of the present disclosure may be practiced. The system and methods presented herein may include a web-based software instance running on a computer or a local software instance located on a user's network. The graphical user interface illustrated in FIG. 9C provides for charts related to income 970, cash balance 980, and a net to heirs 990, all of which can be changed and modified according to numerical changes made to any of the tabs 921-931 depending on the summary age, income tax, capital gain tax, estate tax, policy IRR, investment IRR (pre-tax), investment management fees, investment IRR (post-tax), whether the tax loan will be paid off, at what age the tax loan may be paid off, and the loan interest rate. The user interface disclosed in FIG. 9B is a portion of a dashboard depicted in FIG. 11.

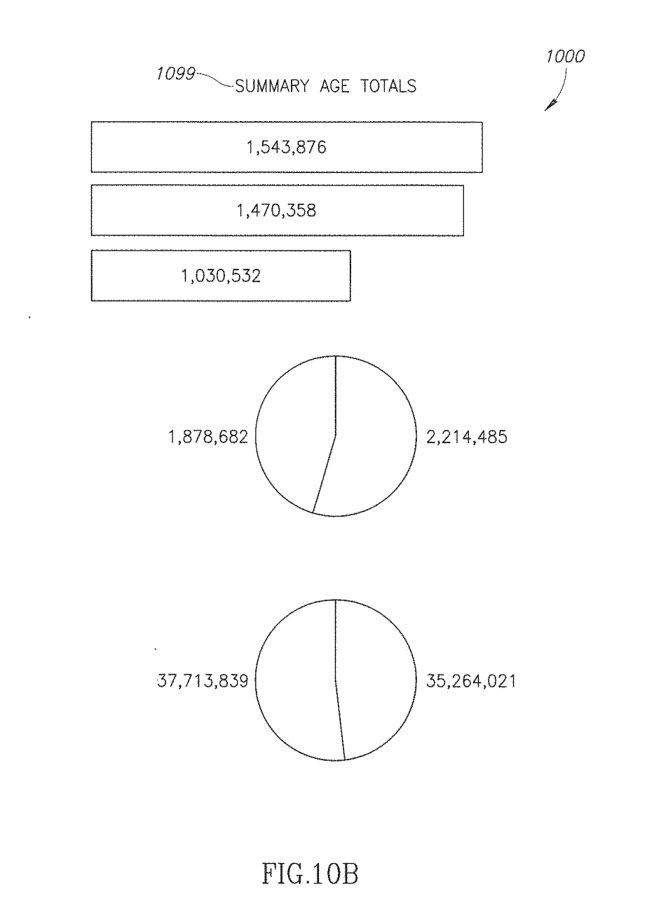

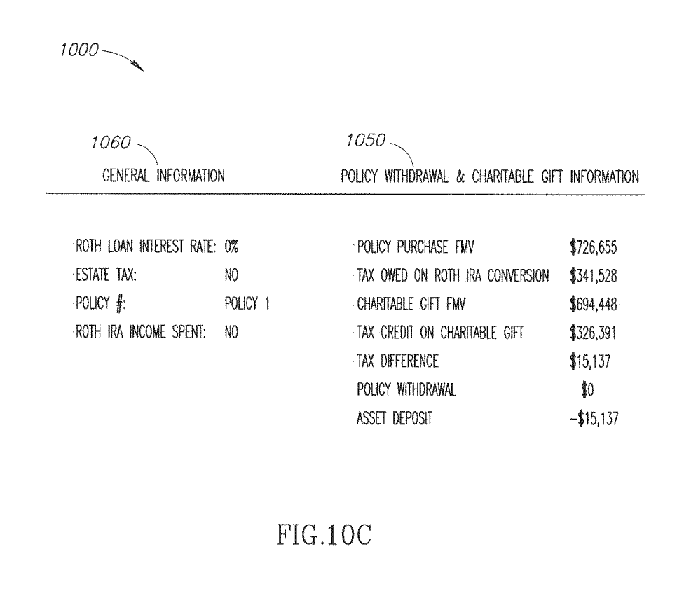

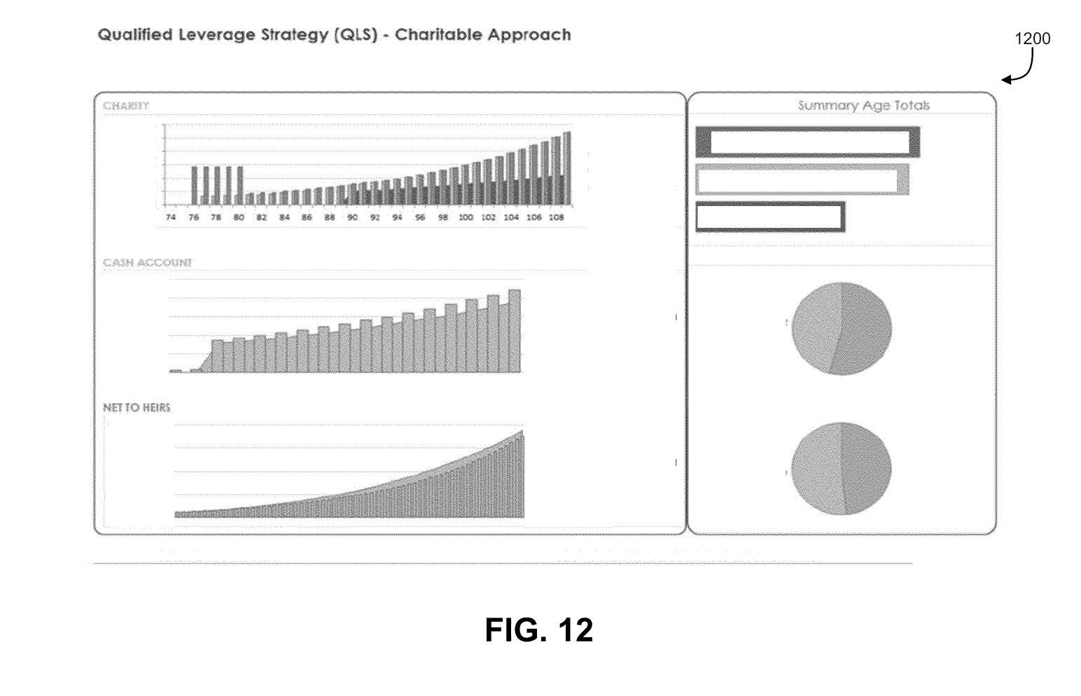

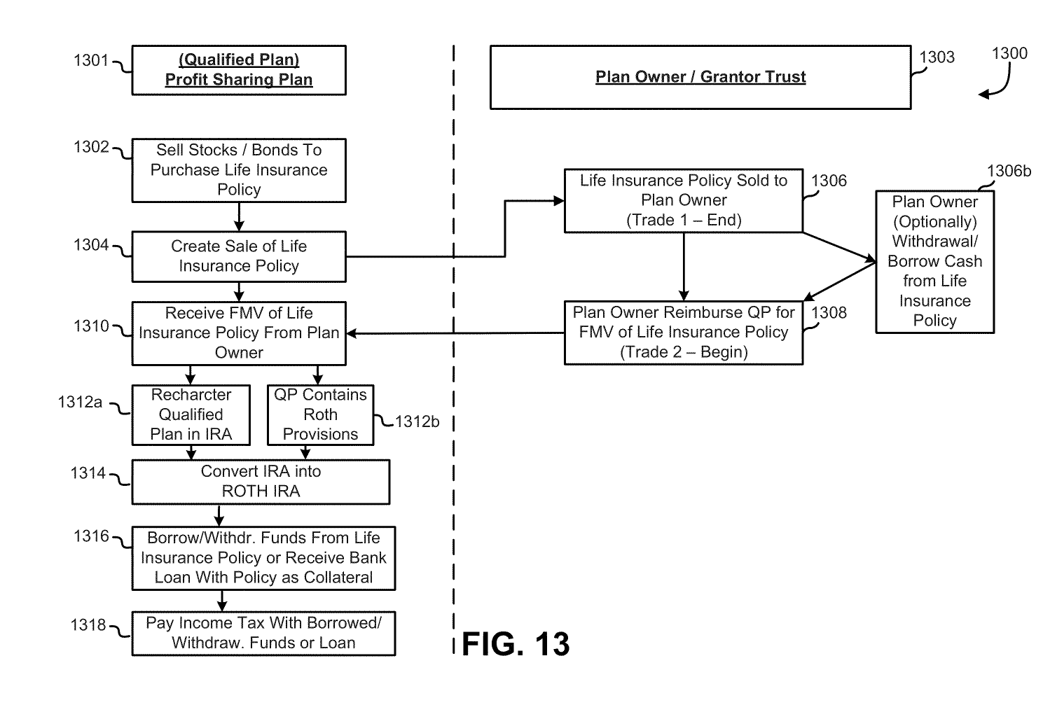

FIG. 10A shows an illustrated example of user interface 1000a in which various embodiments of the present disclosure may be practiced. The user interface is a portion of the charity dashboard as seen in FIG. 12.

The charitable chart 1005 shows the cash value and death benefit of the life insurance policy now usable by the charity. This is compared to the charity waiting for the balance of the qualified plan after required minimum distributions are removed (the shaded area going down). In the cash account chart 1015, the numbers are about equal. This shows the donor holding on to the Roth Ira and enjoying tax-free growth. This is compared to the current plan where the client would have reinvested his required minimum distribution's and held on to the taxable asset that was used to purchase the policy out of the qualified plan.

The chart 1025 illustrates the net finances remaining for the heirs. This assumes that the client dies at age 90 and leaves his Roth IRA to his grandchild who has now reached age 35. This is compared to the RMD side account growing taxable and subject to estate tax and his personal asset account is also subject to estate tax. The present disclosure includes a charitable approach is the only way to get qualified plan money to a charity now without taking a taxable distribution. Structured properly, the client can break even on the cash available to him during his lifetime and (at the same time) pass more wealth on to his heirs.

FIG. 10B shows an illustrated example of a portion of a user interface 1000b in which various embodiments of the present disclosure may be practiced. The embodiment of FIG. 10B discloses a summary goals totals 1099 graph and diagram based on charitable goals under the charity approach of FIG. 10A and FIG. 12.

FIG. 10C shows an illustrated example of a portion of a user interface 1000c in which various embodiments of the present disclosure may be practiced. The embodiment of FIG. 10C discloses a portion of the user interface dashboard of FIG. 12, in which general information 1060 and policy withdrawal and charitable gift information 1050 is provided for a user to adjust the rates in order to view the differences in the policies and options under the charitable approach of FIG. 10A and FIG. 12. Generally, the policy withdrawal and charitable gift information provides for calculations of the FMV when the life insurance policy is sold out of the qualified plan, and, is subsequently gifted directly to a charity or a charitable trust. Example embodiments enables the plan owner to determine if there is tax exposure on the value of the purchase and subsequent gift as well as allow for a separate account in withdrawing money from the insurance policy to account for such a difference. Such examples provide for the tax owed on the Roth IRA conversion, the charitable gift FMV, and the tax credit on the charitable gift. By providing the tax difference and previously withdrawn funds for the life insurance policy, asset deposit may be provided to the plan owner for a benefit of the plan owner.

FIG. 11 shows an illustrated example of a dashboard 1100 in which various embodiments of the present disclosure may be practiced. The dashboard 1100 illustrates the entire graphical user interface as described in FIGS. 9A-9C.

Table of contents 1102 provides for a listing of some example embodiments of available software modules as described in detail in relation to FIG. 9A). The checks module 1102 provides an option to the customer that enables the customer to view any discrepancies that are provided during changes to the dashboard values and entries such that all values are still recognized, legitimate, and applicable. For example, if the assumption were that everything is earning 10%, that means that the beginning value of the PV of premiums tab would begin at a different value; thus, if the value was not adjusted accordingly, the checks warning module would provide an alert to the customer in order to ensure that all values entered are appropriate. In another example, current tax laws require that a newly converted Roth IRA must be in place for at least 5 years before any withdrawals may be taken without penalties; as such, if a customer attempted to withdrawal funds within this five-year window, the checks module 1102 would provide or prompt the customer with a warning describing the problem and a possible solution for same. In another example, if too much money is removed from the Roth IRA, show as a level of income, the checks module would provide a warning to the user that the Roth IRA went negative and the customer is warned to make an adjustment, as the attempt to remove funds would not be feasible.

According to example embodiments, should a customer choose to recognize the economic benefit 1104 (described in detail below), under the “Assets” tab of the user interface, the economic benefit is provided as a cost, which may be the income tax that would be owed for recognizing the economic benefit is shown as a deposit into the assets, which is provided during the comparison of Trade 2 (as reference throughout the present disclosure).

According to current tax laws and regulations (and by way of methods disclosed herein) the decision as to whether or not the participant-insured must pay the annual economic benefit charges measured by the Table 2001 Rates or in certain circumstances forego the payment of the Table 2001 Rate based amounts and attempt to utilize the exception to the general rule set forth in Treas. Reg. 5 1.72-16(b)(6) is a decision to be made by the participant and his or her tax advisor and financial advisor. During the duration of time (normally two to six policy anniversary years) that the policy is a participant account asset per IRC §72(m)(3)(B) and Treas. Reg. §1.72-16(b) the cost of life insurance protection provided under a qualified pension, annuity or profit sharing plan must be included in the employee's gross income for the year in which deductible employer contributions or trust income is applied to purchase life insurance coverage. Technically the trustee of the qualified plan must issue IRS Form 1099 to the employee-participant. The employee is taxed currently on the cost of life insurance protection if the proceeds are either (1) payable to the employee's probate court based estate or a named beneficiary or (2) payable to the profit sharing plan's trustee, if the written plan then requires the trustee to pay the proceeds to the participant's estate or beneficiary. Only the cost of the “net amount at risk” is treated as a currently taxable distribution. This cost is determined by applying the one-year premium rate (normally measured in increments of $1,000.00) at the insured's age to the difference between face amount of the insurance policy and the cash surrender value at the end of the year. The value of the current life insurance protection provided under a qualified plan generally must be determined using the so-called “Table 2001 Rates” (originally published under IRS Notice 2001-10, 2001-5 IRB 459) IRS Notice 2002-8, 2002-4 IRB 398. However, if the insurer's published rates for individual, initial issue, 1 year term policies (available to all standard risks), and these rates are lower than the Table 2001 rates the insurer's rates may be substituted. The benefit of the participant paying the Table 2001 Rate based annual charges is the treatment of the life insurance policy proceeds if the policy is a plan asset (policy ownership and beneficiary titled to the plan) at the time the insured-participant dies. In such a scenario where the insured-participant dies at a moment in time in which the policy is a plan asset the difference between the cash surrender value and the “pure insurance portion” or “net amount at risk” is treated as death proceeds of life insurance, and is excluded from income under IRC §101(a) but only if the cost under Table 2001 has been taxable to the employee participant. The balance of the proceeds (constituting the policy cash surrender value) is treated as a taxable distribution from the plan under IRC §72(m)(3) and Treas. Reg. §1.72-16(c). Certain items may be subtracted from the policy's cash surrender value that is treated as a taxable distribution including the aggregate sum of the Table 2001 Rate based economic benefit charges if the deceased insured was not a self-employed owner-employee. One significant exception to the “general rule” that the employee-participant must be treated as having received a taxable distribution for the “pure insurance protection” related to the policy is set forth under Treas. Reg. §1.72-16(b)(6). Pursuant to this regulation subparagraph, the primary paragraph shall not apply if the trust has the right under any circumstance to retain any part of the policy proceeds of the life insurance contract. Therefore, if the policy is owned by the qualified plan and the plan itself is named the policy beneficiary so that policy proceeds were an investment purchased by the trustee Treas. Reg. §1.72-16(b)(1) does not apply and the cost of life insurance protection is not included in the employee participant's gross income. The “cost” of such gross income exclusion from this specific subparagraph of the treasury regulation is potentially “paid” under Treas. Reg. §1.72-(c)(4). This treasury regulation requires that in those cases in which the employee neither paid the total cost of the life insurance protection provided under the life insurance contract, nor was taxable under paragraph (b) of Treas. Reg. 51.72-16 that no part of the proceeds of that particular life insurance contract paid to the employee's beneficiary(s) as a death benefit is excluded from income pursuant to IRC §101(a). Therefore the entire distribution to the beneficiary(s) is taxable under IRC §402(a) or 403(a).

Returning to FIG. 11, in the comparison of approaches, the qualified plan owner is given the option to spend or reinvest the required minimum distributions (“RMDs”) that come out of the qualified plan starting at age 70.5 according to current tax laws, which is enabled via the Spend RMDS module 1106 on the Dashboard. These RMDs can show up as a side RMD investment account or show as an income stream on the Dashboard. According to a Roth income module 1108, the module enables a customer to choose the option of equating (or in addition to) the Roth income to the required minimum distributions by taking withdrawals from the Roth IRA. The annual Roth withdrawal module 1110 provides an option for the customer to withdrawal funds, the amount of annual Roth withdrawal module 1112 provides for a visualization of the amount of withdrawals, the age of Roth withdrawal module 1114 provides for an entry of when the Roth withdrawals begin, the years of Roth withdrawal module 1116 provides for an entry of the number of years they withdrawals extend. Under these various assumptions, the customer can be shown the additional income that can be provided by strategies according the example embodiments provided herein.

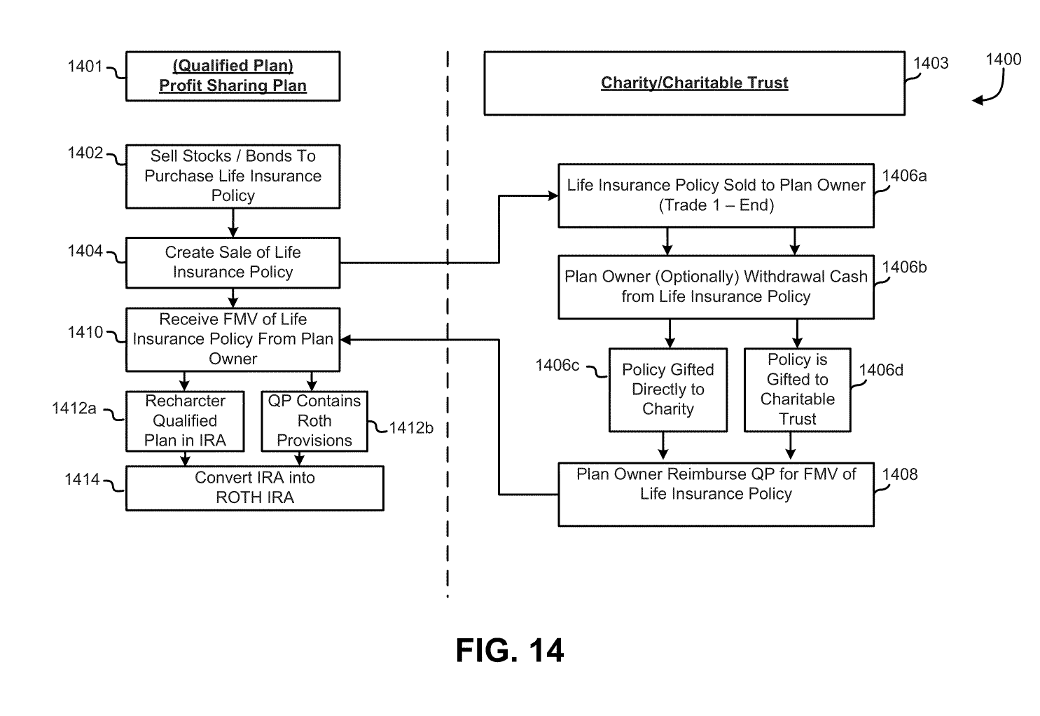

FIG. 12 shows an illustrated example of a dashboard 1200 according to a charitable approach of the present disclosure in which various embodiments may be practiced. The dashboard 1200 illustrates one example embodiment of a graphical user interface as described in FIGS. 10A-10C and further described in the swim diagram as illustrated and depicted in FIG. 14.

FIG. 13 shows a swim diagram 1300 in which various embodiments of the present disclosure may be practiced. The process 1300 may be performed by any suitable system, such as a user computing-device, the routing service, or financial server. The process 1300 includes a step 1302 in which stocks, bonds, or other assets are sold, within a qualified plan, such as a profit sharing plan 1301, to purchase a life insurance policy. At step 1304, a sale of the life insurance policy is created, and the life insurance policy is sold at step 1306 to the plan owner or grantor trust 1303; this assumes the grantor trust has been funded with gifts or loans from the plan owner. At step 1306, according one example embodiment, Trade 1 is considered complete. After Trade 1, the plan owner may optionally take withdrawals or loans from the life insurance policy before Trade 2 begins per step 1306b.

At step 1308, Trade 2 begins; for example, the plan owner must reimburse the qualified plan for the fair market value of the life insurance policy. In other words, once the life insurance policy has been sold to the plan owner per Trade 1, the plan owner owes the fair market value of the life insurance policy to the qualified plan. At step 1310, the qualified plan receives the fair market value for the life insurance policy from the plan owner or grantor trust. At step 1312a, the qualified plan is re-characterized into an investment retirement arrangement. In some example embodiments, at step 1312b, a qualified plan may contain Roth provisions that enable an owner to convert a percentage of the qualified plan to a Roth IRA without having to re-characterize a percentage of the qualified plan into an IRA first, before a Roth IRA conversion is executed.

At step 1314, the IRA conversion to a Roth IRA causes income taxes to become due. At step 1316, the qualified plan can borrow or withdrawal funds from the life insurance policy or receive a bank loan with the life insurance policy as collateral. In the case where a grantor trust is the policy owner, certain trust provisions must be drafted in the trust document in order for the policy values to be used as the asset to pay the Roth IRA tax loan. At step 1318, the qualified plan pays the income tax due using the borrowed funds or loan.

According to example embodiments presented herein, pre-tax dollars inside a qualified plan are traded for a tax-free life insurance policy outside the plan. Supported by a rarely known section of the tax code, a life insurance policy can be purchased inside a qualified retirement plan (with pre-tax dollars) and sold out of the plan, tax-free. Life insurance has always been viewed by Congress as necessary family protection. As a result, life insurance has received preferential tax treatment throughout many areas of the IRS code for over 100 years. In fact, life insurance remains as the only asset with all of the following tax benefits (if properly structured) tax-free growth, tax-free death benefits, and the tax-free access to cash values.

In the area of qualified plans, the IRS has also recognized the need to treat life insurance differently. In circumstance where taxpayers have purchased a life insurance policy inside a qualified plan, the IRS has recognized the potential need to get the policy out of the plan without treating it as a taxable distribution. In practicality, treating the policy as a taxable distribution could result in the taxpayers' need to cannibalize the policy of its internal cash values and (potentially) cause the policy to lapse. As a result, the IRS and DOL have specific rules allowing for a life insurance policy to remain intact by selling it out of the plan, thereby, not treating it as a taxable distribution.

The sale of a policy out of a qualified plan is allowed under two basic conditions: (1) The qualified plan is reimbursed (in cash) for the life insurance policy's fair market value (FMV) and (2) the buyer, the seller and the qualified plan owner are all (essentially) the same person from the standpoint of income tax treatment. The policy can be sold to the qualified plan owner him/herself as an exception to the transfer for value rules. The purchaser can also be an irrevocable life insurance trust (ILIT) as long as the ILIT is considered a “grantor trust” for income tax purposes. (A thorough discussion of the grantor trust rules is beyond the scope of this memo.)

Investment choices inside a life insurance contract can be similar in nature to more traditional investments options (depending on the type of life insurance policy used). Therefore, the real difference in the economics between previous approaches and example embodiments presented herein lies in the tax treatment of dollars once they are removed from the qualified plan. In Trade 1 of example embodiments presented herein, there are no taxes due. After the policy is removed from the qualified plan (via a sale), the long-term cost of example embodiments presented herein (for Trade 1) are the life insurance policy charges. That being said, insurance charges will virtually always be significantly less than the taxes owed on qualified plan distributions. Assuming the first part of the transaction is completed (i.e., a policy was sold out of the qualified plan) the proceeds of the sale of the policy are reimbursed to the qualified plan.

It should be noted that some example embodiments of Trade 1 follow a few specific rules, namely: Prohibited Transaction Exemption 92-6—A life insurance policy can be removed from a qualified plan via a sale and therefore, not counted as a taxable distribution. IRC Rev. Proc. 2005-25—If a life insurance policy is sold or transferred out of a qualified plan, the fair market value (FMV) of the policy must be returned to the qualified plan in cash. The FMV is determined by “safe harbor” rules spelled out in IRC 2005-25 as the greater of the Interpolated Terminal Reserve (ITR) or PERC value (premiums minus reasonable expenses and charges).

Trade 2: Assets are moved/transferred from within a traditional brokerage account (e.g., growing taxable) into a Roth IRA (of equal value) growing tax-free. In alternative example embodiments, the qualified plan can be reimbursed from cash or any other liquid asset.

The life insurance policy can be used to pay the Roth IRA income tax via policy withdrawals or loans or use the policy as collateral for the tax loan on the newly acquired Roth IRA. The life insurance policy may also act as the vehicle to pay back the principal on the tax loan (by either death benefit or cash values).

For example, a taxable growth of $1,000,000 at 7.00%=net growth of 4% or $40,000. Tax-free growth of $1,000,000 at 7%—$70,000 (less) the interest payment on $400,000 at 5% (or 20,000)=$50,000. According to this example, the loan interest would have to be higher than the earnings rate (long term) for there not to be a net benefit, in other words, the plan owner is paying simple interest on a smaller amount in exchange for getting compound interest on a larger amount.

The processes disclosed herein and order of asset reallocation can improve the taxpayers' position on said assets and/or benefit a charitable organization by donating a qualified plan asset during their lifetime. The web-based or instance of the planning software can show economics under different financial assumptions and interest rates.

Traditional assets previously held outside the qualified plan and now in the plan are traded for a Roth IRA and a loan. In a typical example, $1,000,000 of insurance premium is paid into a policy over 3 to 4 years (Trade 1). When the policy is sold and/or transferred out of the qualified plan, approximately $800,000 might be owed back to the qualified plan (insurance policy FMV).

The reimbursement to the qualified plan for the amount owed ($800,000) is the beginning of Trade 2. In the “common approach,” $800,000 would remain invested in a traditional account and the growth would remain taxable. According to example embodiments presented herein, embodiments transform $800,000 of traditional assets into a Roth IRA and a loan. The growth in the Roth IRA is tax-free. The cost of the tax loan is absorbed quickly and easily by the tax-free growth of the Roth IRA. This remains true even if the loan interest is greater than or equal to the IRR on investment returns.

Briefly, the large balance of the Roth IRA is compounding tax-free while the loan interest is designed to be based on a fixed amount (the loan principal). In general, in the absence of Roth IRA provisions within the plan document, defined contribution plans cannot be converted directly to a Roth IRA. However, if first re-characterized as an IRA, a conversion to a Roth IRA is allowed without limitation on the taxpayer's current income.

The power of the economics in Trade 2 relies on the following principle: The tax-free growth of a Roth IRA (plus the cost of a tax loan) provides better economics than the taxable growth of a traditional account. In a simple numeric comparison: both approaches are shown as invested in identical equities that achieve an 8% IRR. Both start with an $800,000 balance. The growth in the traditional account will be income taxable (based on a blended tax rate of 35% the 8% growth on the traditional account will net 5.2%). The Roth IRA will grow income tax free at 8%. However, the instant approach involves a loan; therefore, the loan interest is an additional cost. To account for this cost, the loan interest may be shown as an additional deposit into the traditional asset account of the common approach or shown as withdrawals to the Roth IRA.

For example, trade 2 may be achieved by taking the following steps: (1) Trade 1 is complete, $800,000 is in the qualified plan (the FMV of using $1,000,000 of pre-tax premiums in Trade 1), (2) the qualified plan is then re-characterized as an IRA, (3) the IRA is then converted to a Roth IRA, (4) income tax is owed on the Roth IRA conversion, (5) the policy (from Trade 1) is used as collateral to borrow money to pay the tax on the Roth IRA conversion (or is used to pay the tax on the Roth IRA via policy loans or withdrawals), (6) interest for the tax loan (and possible principal) is paid out of pocket or from the new Roth IRA until the tax loan is paid off, and (7) if the loan lasts until death, the policy death benefit pays off the principal of the loan.

FIG. 14 shows a swim diagram 1400 in which various embodiments of a charitable tax approach according to the present disclosure may be practiced. The process 1400 may be performed by any suitable system, such as a user computing-device, the routing service, or financial server. The process 1400 includes a step 1402 in which stocks, bonds, or other assets are sold, within a qualified plan, such as a profit sharing plan 1401, to purchase a life insurance policy. At step 1404, a sale of the life insurance policy is created, and the life insurance policy is sold at step 1406a to the plan owner. At step 1406a, according one example embodiment, Trade 1 of the charitable approach is considered complete. After Trade 1, the plan owner may optionally take withdrawals or loans from the life insurance policy before Trade 2 begins per step 1406b.

At steps 1406c and 1406d, either the plan owner gifts the policy directly to a charity (1406c) or the plan owner gifts the policy to a charitable trust (1406d), such as a CLAT. This generally creates an income tax deduction for the plan owner. At step 1408, the plan owner must reimburse the qualified plan for the fair market value of the life insurance policy. In other words, once the life insurance policy has been sold to the plan owner per Trade 1, the plan owner owes the fair market value of the life insurance policy to the qualified plan. At step 1410, the qualified plan receives the fair market value for the life insurance policy from the plan owner or grantor trust. At step 1412a, the qualified plan is re-characterized into an investment retirement arrangement. In some example embodiments, at step 1412b, a qualified plan may contain Roth provisions that enable an owner to convert a percentage of the qualified plan to a Roth IRA without having to re-characterize a percentage of the qualified plan into an IRA first, before a Roth IRA conversion is executed.

At step 1414, the IRA conversion to a Roth IRA causes income taxes to become due. If the gift of the policy to a charity or a charitable trust occurs in the same tax year as the Roth IRA conversion, then the taxes owed by the plan owner may be greatly reduced or reduce to zero, being subject to charitable income tax deduction rules and the like.

Currently, some charities know that they will eventually get what is left of someone's qualified plan. However, the donor could change their mind, spend the balance (beyond required minimum distributions) and the charity is out of luck. In addition, many charities need money now and do not want to wait until the donor dies. Until now, there has not been a way (in current law) to give the entire balance of your qualified plan to charity now without first taking a taxable distribution. Example embodiments according to the present disclosure include a charitable approach, which solves the problem for charities and (at the same time) can be designed to keep the plan owner in a similar cash position and/or pass more wealth down to the plan owner's heirs.

Due to well-established (but not well-known) rules, a life insurance policy can be purchased inside a qualified plan and sold out of the plan (to the plan owner) without being treated as a taxable distribution. Once the policy is sold out of the qualified plan, a person with a charitable intent can give that policy to charity for the benefit of the charity. In another example embodiment, the policy owner would be an irrevocable trust known as Charitable Lead Annuity Trust or “CLAT.” The gift of the policy directly to a charity or a “CLAT” creates an income tax deduction for the qualified plan owner. This type of trust under which both individuals and charitable organizations are beneficiaries per the IRS is what is known generally as a “split interest trust.” Income, through an annuity stream, is paid to a charity or charities set forth under the written terms of the trust, at least annually. The duration of the stream is chosen by the grantor or grantors of the trust. The amount of the annual annuity is chosen by the grantor or grantors as well. The longer the duration of the stream and/or the larger the annuity amount will affect the charitable income tax deduction under section 170 of the Internal Revenue Code. Said “lead annuity” amount is also a charitable gift not subject to federal gift taxation. The remainder interest may be subject to federal gift taxation.

In the same tax year, the qualified plan owner is also required to reimburse the qualified plan for the fair market value of the policy that was sold out (and gifted to the charity). The plan owner uses taxable assets (from within his estate) to reimburse his qualified plan. In further example embodiments, the client or customer created an income tax deduction in that same tax year when he donated his life insurance policy to charity. In some situations, based on IRS deduction limits, the tax due on the Roth IRA conversion can be minimized or zeroed out, once the plan owner converts the reimbursed qualified plan to a Roth IRA. The client has converted taxable assets in his estate to a tax-free Roth IRA, made a great gift for charity, and created a valuable asset to his heirs in the form of an inherited Roth IRA. The Roth IRA can be further enhanced in value based on beneficiary designations passing the inherited Roth IRA to future generations enjoying income tax-free growth on the account (minus the required distributions).

At the end of the duration of the annuity stream being paid to the charitable organization(s) the trust provides that the remainder interest (if any) may pass to the grantor's chosen beneficiaries (normally children and/or grandchildren). During the grantor's life, the trust may be either a grantor trust or non-grantor trust for federal income tax purposes but in order for the grantor to obtain the income tax deduction the CLAT must be a grantor trust under sections 671-679 of the Internal Revenue Code.

To the extent that appreciation in the trust corpus exceeds the annuity rate over the duration of the “lead annuity,” interest said amount is being distributed to the chosen beneficiaries free of gift and estate taxation. A donation of a life insurance policy to a grantor trust CLAT would cause the realization and recognition of an income tax deduction under section 170 of the code that could in theory eliminate or help mitigate the realization and recognition of income tax upon the conversion of a traditional IRA to a Roth IRA so long as both events occurred in the same tax year. The trustee would then utilize policy cash surrender values to pay the lead annuity interest to the chosen charitable organization(s).

In further example embodiments, the trustee could convert the life insurance policy to an annuity, in the form of a Section 1035 exchange, to further enhance the economics depending on who the trustee wants to benefit (subject to the terms of the trust).

Further examples of a Roth IRA plus a loan versus a traditional investment are provided below for a detailed illustration purpose only.

Roth IRA plus a Loan (referred to as a
Financed Roth IRA) vs. Traditional Investment
Financed Roth IRA vs. Traditional Investment

| Balance | | $968,529 | IRR after Tax |
|---|---|---|---|
| IRR (Pre-tax and After-tax) | | 6.64% | 3.67% |
| Asset Management Fee | | 1.00% | |
| Income Tax Rate | | 40% | |
| Roth tax Load (Amount) | | 60% | |
| Payoff Loan? | | No | |
| Year to Payoff Loan | | | |
| Loan Interest Rate | | 6.00% | |
| Loan Payments | | $23,245 | |
| Year | Investment | Roth IRA | Gain |
| 1 | $1,027,280 | $1,032,839 | $5,559 |
| 2 | $1,088,185 | $1,101,420 | $13,235 |
| 3 | $1,151,322 | $1,174,554 | $23,232 |
| 4 | $1,216,774 | $1,252,545 | $35,770 |
| 5 | $1,284,626 | $1,335,713 | $51,087 |
| 6 | $1,354,966 | $1,424,405 | $69,440 |
| 7 | $1,427,883 | $1,518,985 | $91,102 |
| 8 | $1,503,474 | $1,619,846 | $116,372 |
| 9 | $1,581,836 | $1,727,404 | $145,568 |
| 10 | $1,663,071 | $1,842,103 | $179,033 |
| 15 | $2,116,160 | $2,540,474 | $424,313 |
| 20 | $2,658,618 | $3,503,607 | $844,989 |
| 25 | $3,308,070 | $4,831,879 | $1,523,809 |
| 30 | $4,085,621 | $6,663,720 | $2,578,098 |
| 35 | $5,016,538 | $9,109,040 | $4,173,502 |
| 40 | $6,131,070 | $12,674,128 | $6,543,058 |

Traditional Investment with Roth Interest Deposit

| Year | Balance | Beg. of Year | 3.67% | End of Year | Interest Pmt | Balance |
|---|---|---|---|---|---|---|
| 1 | $968,529 | $968,529 | $35,506 | $1,004,035 | $23,245 | $1,027,280 |
| 2 | | $1,027,280 | $37,660 | $1,064,940 | $23,245 | $1,088,185 |
| 3 | | $1,088,185 | $39,893 | $1,128,078 | $23,245 | $1,151,322 |
| 4 | | $1,151,322 | $42,207 | $1,193,530 | $23,245 | $1,216,774 |
| 5 | | $1,216,774 | $44,607 | $1,261,381 | $23,245 | $1,284,626 |
| 6 | | $1,284,626 | $47,094 | $1,331,721 | $23,245 | $1,354,965 |
| 7 | | $1,354,965 | $49,673 | $1,404,638 | $23,245 | $1,427,883 |
| 8 | | $1,427,883 | $52,346 | $1,480,229 | $23,245 | $1,503,474 |
| 9 | | $1,503,474 | $55,117 | $1,558,591 | $23,245 | $1,581,836 |
| 10 | | $1,581,836 | $57,990 | $1,639,826 | $23,245 | $1,663,071 |
| 11 | | $1,663,071 | $60,968 | $1,724,039 | $23,245 | $1,747,284 |
| 12 | | $1,747,284 | $64,055 | $1,811,339 | $23,245 | $1,834,584 |
| 13 | | $1,834,584 | $67,256 | $1,901,839 | $23,245 | $1,925,084 |
| 14 | | $1,925,084 | $70,574 | $1,995,658 | $23,245 | $2,018,902 |
| 15 | | $2,018,902 | $74,013 | $2,092,915 | $23,245 | $2,116,160 |
| 16 | | $2,116,160 | $77,578 | $2,193,739 | $23,245 | $2,216,983 |
| 17 | | $2,216,983 | $81,275 | $2,298,258 | $23,245 | $2,321,503 |
| 18 | | $2,321,503 | $85,106 | $2,406,609 | $23,245 | $2,429,854 |
| 19 | | $2,429,854 | $89,078 | $2,518,932 | $23,245 | $2,542,177 |
| 20 | | $2,542,177 | $93,196 | $2,635,082 | $23,245 | $2,658,618 |
| 21 | | $2,658,618 | $97,465 | $2,756,082 | $23,245 | $2,779,327 |
| 22 | | $2,779,327 | $101,890 | $2,881,217 | $23,245 | $2,904,462 |
| 23 | | $2,904,462 | $106,478 | $3,010,940 | $23,245 | $3,034,184 |
| 24 | | $3,034,184 | $111,233 | $3,145,417 | $23,245 | $3,168,662 |
| 25 | | $3,168,662 | $116,163 | $3,284,825 | $23,245 | $3,308,070 |
| 26 | | $3,308,070 | $121,274 | $3,429,344 | $23,245 | $3,452,589 |
| 27 | | $3,452,589 | $126,572 | $3,579,160 | $23,245 | $3,602,405 |
| 28 | | $3,602,405 | $132,064 | $3,734,469 | $23,245 | $3,757,714 |
| 29 | | $3,757,714 | $137,758 | $3,895,472 | $23,245 | $3,918,716 |
| 30 | | $3,918,716 | $143,660 | $4,062,377 | $23,245 | $4,085,621 |
| 31 | | $4,085,621 | $149,779 | $4,235,400 | $23,245 | $4,258,645 |
| 32 | | $4,258,645 | $156,122 | $4,414,767 | $23,245 | $4,438,012 |
| 33 | | $4,438,012 | $162,698 | $4,600,709 | $23,245 | $4,623,954 |
| 34 | | $4,623,954 | $169,514 | $4,793,468 | $23,245 | $4,816,713 |
| 35 | | $4,816,713 | $176,581 | $4,993,293 | $23,245 | $5,016,538 |
| 36 | | $5,016,538 | $183,906 | $5,200,444 | $23,245 | $5,223,689 |
| 37 | | $5,223,689 | $191,500 | $5,415,189 | $23,245 | $5,438,434 |
| 38 | | $5,438,434 | $199,373 | $5,637,807 | $23,245 | $5,661,052 |
| 39 | | $5,661,052 | $207,534 | $5,868,586 | $23,245 | $5,891,831 |
| 40 | | $5,891,831 | $215,995 | $6,107,825 | $23,245 | $6,131,070 |

Roth IRA and a Loan

| | | | | Pay Off | |
|---|---|---|---|---|---|
| | | | | Loan | |
| | | | | Principal or | |
| | | | | Withdrawal | |
| Year | Balance | Beg of Year | 6.64% | Loan Interest | End of Year |

| | | | | |
|---|---|---|---|---|
| 1 | $968,529 | $968,529 | $64,310 | $1,032,839 |
| 2 | | $1,032,839 | $68,581 | $1,101,420 |
| 3 | | $1,101,420 | $73,134 | $1,174,554 |
| 4 | | $1,174,554 | $77,990 | $1,252,545 |
| 5 | | $1,252,545 | $83,169 | $1,335,713 |
| 6 | | $1,335,713 | $88,691 | $1,424,405 |
| 7 | | $1,424,405 | $94,580 | $1,518,985 |
| 8 | | $1,518,985 | $100,861 | $1,619,846 |
| 9 | | $1,619,846 | $107,558 | $1,727,404 |
| 10 | | $1,727,404 | $114,700 | $1,842,103 |
| 11 | | $1,842,103 | $122,316 | $1,964,419 |
| 12 | | $1,964,419 | $130,437 | $2,094,856 |
| 13 | | $2,094,856 | $139,098 | $2,233,955 |
| 14 | | $2,233,955 | $148,335 | $2,382,290 |
| 15 | | $2,382,290 | $158,184 | $2,540,474 |
| 16 | | $2,540,474 | $168,687 | $2,709,161 |
| 17 | | $2,709,161 | $179,888 | $2,889,049 |
| 18 | | $2,889,049 | $191,833 | $3,080,882 |
| 19 | | $3,080,882 | $204,571 | $3,285,453 |
| 20 | | $3,285,453 | $218,154 | $3,503,607 |
| 21 | | $3,503,607 | $232,639 | $3,736,246 |
| 22 | | $3,736,246 | $248,087 | $3,984,333 |
| 23 | | $3,984,333 | $264,560 | $4,248,893 |
| 24 | | $4,248,893 | $282,126 | $4,531,019 |
| 25 | | $4,531,019 | $300,860 | $4,831,879 |
| 26 | | $4,831,879 | $320,837 | $5,152,716 |
| 27 | | $5,152,716 | $342,140 | $5,494,856 |
| 28 | | $5,494,856 | $364,858 | $5,859,714 |
| 29 | | $5,859,714 | $389,085 | $6,248,799 |
| 30 | | $6,248,799 | $414,920 | $6,663,720 |
| 31 | | $6,663,720 | $442,471 | $7,106,191 |
| 32 | | $7,106,191 | $471,851 | $7,578,042 |
| 33 | | $7,578,042 | $503,182 | $8,081,224 |
| 34 | | $8,081,224 | $536,593 | $8,617,817 |
| 35 | | $8,617,817 | $572,223 | $9,190,040 |
| 36 | | $9,190,040 | $610,219 | $9,800,259 |
| 37 | | $9,800,259 | $650,737 | $10,450,996 |
| 38 | | $10,450,996 | $693,946 | $11,144,942 |
| 39 | | $11,144,942 | $740,024 | $11,884,966 |
| 40 | | $11,884,966 | $789,162 | $12,674,128 |

The above-tables are one example embodiment of the Roth IRA and loan according to example embodiments presented herein. It will be understood by those of knowledge in the art that other factors and financial options may be used; for example, an interest payment could be a withdrawal on the Roth IRA instead of a deposit on a traditional account.

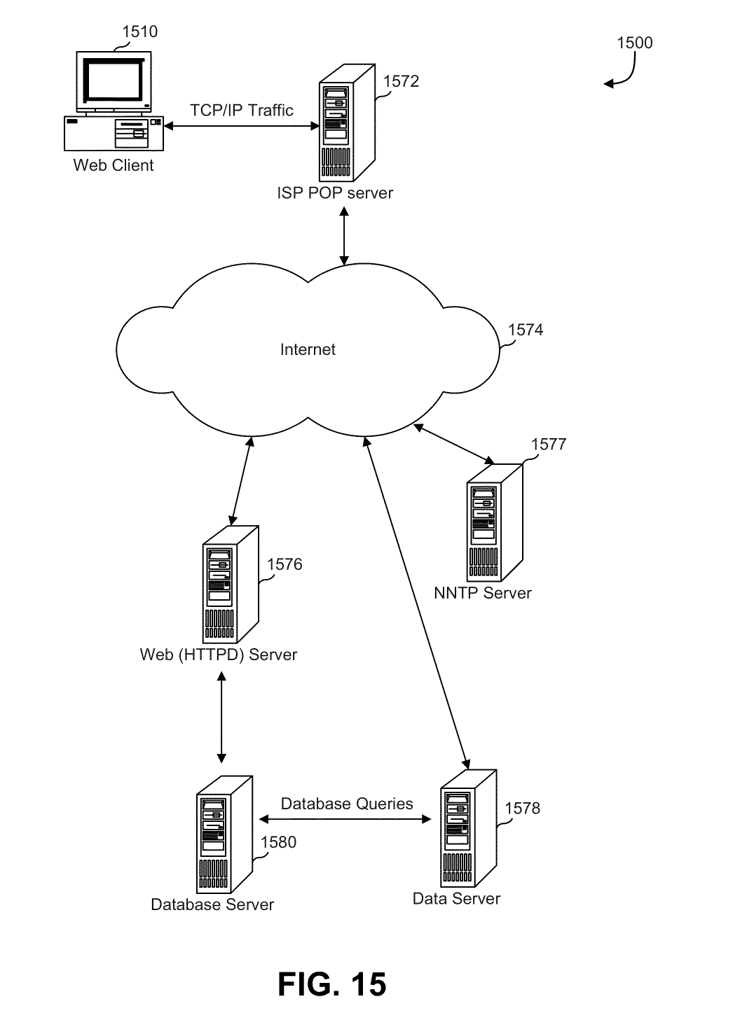

FIG. 15 illustrates aspects of an example environment 1500 for implementing aspects in accordance with various embodiments. As will be appreciated, although a web-based environment is used for purposes of explanation, different environments may be used, as appropriate, to implement various embodiments. The environment includes an electronic client device, such as the web client 1510, which can include any appropriate device operable to send and/or receive requests, messages, or information over an appropriate network 1574 and, in some embodiments, convey information back to a user of the device. Examples of such client devices include personal computers, cell phones, laptop computers, tablet computers, embedded computer systems, electronic book readers, and the like. In this example, the network includes the Internet, as the environment includes a web server 1576 for receiving requests and serving content in response thereto and at least one application server 1577. It should be understood that there could be several application servers. Servers, as used herein, may be implemented in various ways, such as hardware devices or virtual computer systems. In some contexts, servers may refer to a programming module being executed on a computer system. The example further illustrate a database server 1580 in communication with a data server 1578, which may include or accept and respond to database queries.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

While example embodiments presented herein pertain primarily to funds and benefits of the United States of America, other tax revenue and tax qualified plans from other countries in the world may similarly apply using their respective tax laws, codes, and regulations.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein

APPENDIX A
Example Embodiment of Data Tab

| Universal Inputs (scenarios) | |
|---|---|
| Clients name | charitable client |
| Clients current age | 55 |
| Joint client age (older) | |
| Summary age | 90 |
| Final Summary Age | 100 |
| Age of Oldest Estate Beneficiary | 15 |
| Age of Estate Beneficiary at Summary Age | 50 |
| Income tax rate | 47% |
| Blended tax rate (dividends/cap gain) | 35% |
| Estate tax rate | 40% |
| Pre-tax investment IRR | 6.64% |
| Asset Management Fee (AUM) | 0.00% |
| Pre-tax investment IRR (−1% AUM Fee) | 6.64% |
| After Tax investment IRR | 4.32% |
| FMV all values | $1,733,200 |
| Years of Pre-Tax Premiums Paid | 3 |
| Age of Policy Buyout | 57 |
| FMV age (Roth conversion/deposit for asset) | 57 |
| Recognize Economic Benefit? | Yes |
| Show Non-Repositioned Retirement Fund | No |
| Assets Premiums as gifts | |
| Life Policy # | Policy 1 |
| Youngest Clients current age (s) | 55 |
| Age at policy Sale | 57 |
| FMV of policy at Sale | $1,733,200 |
| Income tax rate | 47% |
| Premiums paid | $667,000 |
| Years Pre-Tax Premiums Paid | 3 |
| Policy interest rate | 6.64% |
| Policy Death Benefit | $10,395,300 |
| Present value of QP Premiums | $1,762,000 |
| Annual income | $0 |
| PV of Premiums calc | $5 |
| Assets in qualified plan | |
| Clients current age | 55 |
| Qualified Plan Balance | $1,762,000 |
| Income tax rate | 47% |
| Blended tax rate (dividends/cap gain) | 35% |
| Estate tax rate | 40% |
| Pre-tax investment IRR | 6.64% |
| After Tax investment IRR | 4.32% |
| Annual contributions | $0.00 |
| Age of contributions (start age) | 73 |
| Age of contributions (end age) | 85 |
| Annual withdrawal amount - manual | |
| Annual withdrawal amount | $0.00 |
| Annual withdrawal value after tax | $0 |
| Age of withdrawals | 73 |
| Years of level withdrawals (default 0) | 0 |
| Plan values at end of year 0 | $5,303,094.14 |
| Plan goes negative at: | Never |
| RMDs beginning age _ (70.5 default) | 70.5 |
| Spend RMDs as income | Yes |
| RMD side fund | |
| RMD fund beginning age (ENTER AGE) (default) | 70.5 |
| Income tax rate | 47% |
| Blended tax rate (dividends/cap gain) | 35% |
| Estate tax rate | 40% |
| Pre-tax investment IRR | 6.64% |
| After Tax investment IRR | 4.32% |
| Assets in estate | |
| Clients current age | 55 |
| Clients age at policy sale | 57 |
| Estate Asset (amount) | $1,733,200.00 |
| Income tax rate | 47% |
| Estate tax rate | 40% |
| Pre-tax IRR | 6.64% |
| After Tax IRR | 4.32% |
| Interest deposit (amounts) | $40,730.20 |
| Ongoing deposits (start age) | 57 |
| Ongoing deposits (end age) | 100 |
| Income difference | $0.00 |
| Ongoing withdrawal (amounts) - manual | $0.00 |
| Ongoing withdrawal (amounts) | $0.00 |
| Ongoing withdrawal (start age) | 70 |
| Ongoing withdrawal (years) | 29 |
| Plan goes negative at: | Never |
| Roth IRA conversion (pay the tax) | |
| Clients current age | 55 |
| Clients age at conversion | 57 |
| Roth Plan Balance (equals FMV) | $1,733,200.00 |
| Income tax rate | 47% |
| Income tax paid | $814,604.00 |
| Roth Plan Balance (after-tax) | $918,596.00 |
| Estate tax rate | 40% |
| Pre-tax investment IRR | 6.64% |
| Financed Roth IRA (Roth IRA + Loan) | |
| (borrow the tax) | |
| Clients current age | 55 |
| Clients age at conversion | 75 |
| Roth Plan Balance (equals FMV) | $1,733,200.00 |
| Income tax rate | 47% |
| Roth conversion tax due | $814,604.00 |
| Roth conversion tax loan | $814,604.00 |
| Interest rate on tax loan | 5.00% |
| Interest paid on tax loan | $40,730.20 |
| Pay off tax Loan? | No |
| Age to pay off tax loan | 65 |
| Year to pay off tax loan | 2 |
| Pre-tax investment IRR | 6.64% |
| Annual level withdrawal amount | −$200,000 |
| Ongoing withdrawal (amounts) | $0.00 |
| Age of withdrawals | 75 |
| Years of level withdrawals (default 0) | 15 |
| Do you want income equal to RMD? | Yes |
| How will you show non-Repositioned | Roth IRA |
| Retirement Fund Assets premiums? | Withdrawals |
| Go negative at age: | Never |
| Beneficiary Inputs | |
| Apply Estate and/or GST Tax? | No |
| Show Roth RMD as Income? | No |
| Match with Current Plan? | No |
| Level Withdrawals | |
| Annual Level Withdrawals | No |
| Match with Current Plan? | No |
| Withdrawal Amount | $0 |
| Withdrawal Start Age | 64 |
| Withdrawal Years | 15 |

What is claimed is:

1. A computer-implemented method, using computer hardware and/or computer software that can be processed by a processor and memory storage, for managing data related to a multi-part investment strategy, the method comprising:
using a processor to effect a purchase of a life insurance policy for an investor as a plan asset for a qualified plan;
selling the life insurance policy, after at least some initial period, to the investor outside of the qualified plan;
funding the selling of the life insurance policy using non-qualified traditional assets;
converting the qualified plan to a Roth investment retirement account (IRA); and
paying taxes due on the Roth IRA conversion with funds borrowed using a previously acquired life insurance policy.

2. The computer-implemented method of claim 1, wherein the multi-part investment strategy includes a wealth-transfer, retirement, or charitable investment strategy.

3. The computer-implemented method of claim 1, wherein the selling of the life insurance policy is directly to the investor or via a grantor trust having at least a plan owner as the grantor of the grantor trust.

4. The computer-implemented method of claim 1, wherein the funds borrowed are funds borrowed or withdrawn from the life insurance policy.

5. The computer-implemented method of claim 1, wherein the funds borrowed are proceeds of a loan in which the life insurance policy was used as collateral for the loan.

6. The computer-implemented method of claim 1, wherein principal on the taxes paid on the Roth IRA conversion using funds withdrawn according to a previously acquired life insurance policy is paid with personal funds and/or death benefits or cash values of the previously acquired life insurance policy.

7. A system, comprising:
at least one computing device configured to implement one or more services, wherein the one or more services are configured to:
cause a processor to effect a purchase of a life insurance policy for a first party as a plan asset for a qualified plan;
sell the life insurance policy to a second party, the second party being outside of the qualified plan;
finance the selling of the life insurance policy using non-qualified traditional assets; and
convert the qualified plan to a Roth investment retirement account (IRA).

8. The system of claim 7, wherein taxes are paid on the Roth IRA conversion using funds withdrawn according to a previously acquired life insurance policy.

9. The system of claim 7, wherein interest on taxes paid on the Roth IRA conversion using funds withdrawn according to a previously acquired life insurance policy is paid for up to the life of the insured.

10. The system of claim 7, wherein principal on taxes paid on the Roth IRA conversion using funds withdrawn according to a previously acquired life insurance policy or paid according to trust documents.

11. The system of claim 7, wherein a fair market value of the life insurance policy is received at the qualified plan via an owner of the life insurance policy.

12. The system of claim 7, wherein causing the processor to effect the purchase of the life insurance policy includes enabling the first party to utilize the qualified plan assets to make the purchase.

13. The system of claim 7, wherein the qualified plan assets include stocks bonds or other assets in a profit sharing plan.

14. The system of claim 7, further configured to monitor a status a policy owner, wherein the policy owner is a qualified plan owner or a grantor trust.

15. The system of claim 7, wherein a policy owner is a charitable trust.

16. The system of claim 7, wherein the one or more services are configured to use pre-tax assets to purchase the life insurance policy.

17. A non-transitory computer-readable storage medium having stored thereon executable instructions that, when executed by one or more processors of a computer system, cause the computer system to at least:
cause, via a network service, a purchase of a life insurance policy, for a policy owner, as a plan asset for a qualified plan, the policy owner being the qualified plan;
transfer the life insurance policy;
fund the transfer of the life insurance policy;
convert the qualified plan to a Roth investment retirement account (IRA); and
pay taxes due on the Roth IRA conversion with funds borrowed or withdrawn using a previously acquired life insurance policy.

18. The non-transitory computer-readable storage medium of claim 17, wherein the funds are borrowed directly from the life insurance policy or the life insurance policy is used as collateral for a loan.

19. The non-transitory computer-readable storage medium of claim 17, wherein transferring the life insurance policy includes selling the life insurance policy.
